(19) United States
(12) Patent Application Publication
(10) Pub. No.: US 2009/0015768 A1
(43) Pub. Date: Jan. 15, 2009

(54) Liquid crystal display device

(75) Inventors: Koichi Igeta, Chiba (JP); Junji Tanno, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/216,554

(22) Filed: Jul. 8, 2008

(30) Foreign Application Priority Data
Jul. 11, 2007 (JP) 2007-181701

(51) Int. Cl. G02F 1/1335; G02F 1/1343

(52) U.S. Cl. 349/106; 349/144

(57) ABSTRACT

The present invention enhances a numerical aperture of a liquid crystal display device having color filters. In a liquid crystal display device including a liquid crystal display panel which has a first substrate, a second substrate, and a liquid crystal layer sandwiched between the first substrate and the second substrate, the liquid crystal display panel includes a light blocking film and a plurality of sub pixels arranged in a matrix array, each one of the plurality of sub pixels includes a pixel electrode, a counter electrode and a color filter, an electric field is generated between the pixel electrode and the counter electrode thus driving liquid crystal of the liquid crystal layer. The plurality of sub pixels includes two neighboring sub pixels which are arranged adjacent to each other along the direction of a display line and have the color filters of the same color. The light blocking film is formed so as to cover respective pixel boundaries of the plurality of sub pixels except for the pixel boundary between the two neighboring sub pixels. The respective pixel electrodes of the two neighboring sub pixels are formed independently from each other.

The present application claims priority from Japanese application JP2007-181701 filed on Jul. 11, 2007, the content of which is hereby incorporated by reference into this application.

### BACKGROUND OF THE INVENTION

1. Field of the Invention

The present invention relates to a liquid crystal display device, and more particularly to a technique effectively applicable to a liquid crystal display device having color filters.

2. Description of the Related Art

A liquid crystal display device includes, irrespective of a display method, color filters for performing a color display. As colors used in the color filters, three primary colors consisting of red, green and blue are used, and one basic unit (1 pixel) is constituted of red, green and blue sub pixels.

The present invention relates to a liquid crystal display device having color filters, and as the related art, JP-A-11-84365 (patent document 1), JP-A-2002-107709 (patent document 2), and JP-A-2005-62220 (patent document 3) are named.

### SUMMARY OF THE INVENTION

The liquid crystal display device usually includes a light blocking film such as a black matrix between sub pixels for avoiding mixing of colors consisting of red, green and blue. The light blocking film is provided mainly due to following reasons.

(1) In a manufacturing step of color filters, first of all, the black matrix is formed by a photolithography method and, thereafter, color resists are formed in the same manner by a photolithography method in order of red, green and blue. Here, although a gap between colors or the superposition of colors is generated due to the misalignment in the respective photolithography steps of red, green and blue, the black matrix is formed with a manufacturing margin to prevent the appearance of the gap between colors or the superposition of colors on a display.

(2) The misalignment is generated when a TFT substrate (array substrate) and a CF substrate (color filter substrate) overlap with each other. Although there exists a possibility that the different color appears in the neighboring sub pixel when the misalignment is large, the black matrix is formed with the manufacturing margin to prevent the appearance of the difference in color on the display.

Unless the light blocking film is provided, color mixing is generated between the sub pixels of different colors attributed to the misalignment during the manufacturing step thus remarkably lowering display quality including lowering of color reproducibility. However, when a light blocking film is formed between the sub pixels for preventing color mixing, there arises a drawback that a numerical aperture is lowered.

Although when a size of the pixel is large, the influence of the light blocking film on the numerical aperture is small, along with a demand for high definition which requires the reduction of the size of the pixel, a ratio that the light blocking film occupies in the sub pixel is increased thus lowering the numerical aperture. When the numerical aperture is lowered, the display brightness is lowered and hence, display quality is remarkably lowered. On the other hand, when the brightness of a backlight is increased to maintain the display brightness, there arises a drawback that the power consumption is increased.

The present invention has been made to overcome the above-mentioned drawbacks of the related art, and it is an object of the present invention to provide a technique which can enhance a numerical aperture in a liquid crystal display device.

The above-mentioned and other objects and novel features of the present invention will become apparent from the description of this specification and attached drawings.

To briefly explain the summary of typical inventions among the inventions disclosed in this specification, they are as follows.

(1) In a liquid crystal display device including a liquid crystal display panel which has a first substrate, a second substrate, and a liquid crystal layer sandwiched between the first substrate and the second substrate, wherein the liquid crystal display panel includes a light blocking film and a plurality of sub pixels arranged in a matrix array, each one of the plurality of sub pixels includes a pixel electrode, a counter electrode and a color filter, an electric field is generated between the pixel electrode and the counter electrode thus driving liquid crystal of the liquid crystal layer, wherein the plurality of sub pixels includes two neighboring sub pixels which are arranged adjacent to each other along the direction of a display line and have the color filters of the same color, the light blocking film is formed so as to cover respective pixel boundaries of the plurality of sub pixels except for the pixel boundary between the two neighboring sub pixels, and the respective pixel electrodes of the two neighboring sub pixels are formed independently from each other.

(2) In the liquid crystal display device having the above-mentioned constitution (1), the two neighboring sub pixels share the color filter in common.

(3) In the liquid crystal display device having the above-mentioned constitution (1) or (2), the plurality of sub pixels is divided into three sub pixels of a first group which are arranged in order of first color, second color and third color, and three sub pixels of a second group which are arranged in order of the third color, the second color and the first color, and the three sub pixels of the first group and the three sub pixels of the second group are alternately arranged in the direction of the display line.

(4) In the liquid crystal display device having any one of the above-mentioned constitutions (1) to (3), the pixel electrodes and the counter electrodes are formed on the first substrate, and the color filters and the light blocking film are formed on the second substrate.

(5) In the liquid crystal display device having the constitution (4), the pixel electrode and the counter electrode are stacked to each other by way of an insulation film.

(6) In the liquid crystal display device having the constitution (4), the pixel electrode and the counter electrode are formed on the same layer.

(7) In the liquid crystal display device having any one of the above-mentioned constitutions (4) to (6), each one of the plurality of sub pixels includes a transmissive portion and a reflective portion.

(8) In the liquid crystal display device having any one of the above-mentioned constitutions (1) to (3), the pixel electrodes are formed on the first substrate, and the color filters, the light blocking film and the counter electrodes are formed on the second substrate.

(9) In the liquid crystal display device having the constitution (8), each one of the plurality of sub pixels includes a transmissive portion and a reflective portion.

(10) In the liquid crystal display device having any one of the above-mentioned constitutions (1) to (9), the plurality of sub pixels is arranged such that the sub pixels of the same color are arranged adjacent to each other between two neighboring display lines.

(11) In the liquid crystal display device having any one of the above-mentioned constitutions (1) to (9), the plurality of sub pixels is arranged such that the sub pixels of different colors are arranged adjacent to each other between two neighboring display lines.

(12) In the liquid crystal display device having any one of the above-mentioned constitutions (1) to (9) and (11), assuming that two neighboring display lines are constituted of one display line and another display line, the two neighboring sub pixels on the one display line and the two neighboring sub pixels on the another display line are arranged adjacent to each other, and the respective color filters have different colors from each other.

(13) In a liquid crystal display device including a liquid crystal display panel which has a first substrate, a second substrate, and a liquid crystal layer sandwiched between the first substrate and the second substrate, and a video line drive circuit, wherein the liquid crystal display panel includes a plurality of sub pixels arranged in a matrix array, and a plurality of video lines which supplies video voltages to the respective sub pixels of the plurality of sub pixels, each one of the plurality of sub pixels includes a pixel electrode and a counter electrode, and an electric field is generated between the pixel electrode and the counter electrode thus driving liquid crystal of the liquid crystal layer, wherein the plurality of sub pixels is divided into three sub pixels of a first group which are arranged in order of first color, second color and third color, and three sub pixels of a second group which are arranged in order of the third color, the second color and the first color, the three sub pixels of the first group and the three sub pixels of the second group are alternately arranged in the direction of the display line, and the respective pixel electrodes of two neighboring sub pixels formed of the sub pixels of the same color arranged adjacent to each other along the direction of the display line are formed independently from each other, output terminals of the video line drive circuit are arranged sequentially in order of the first color, the second color and the third color, and a video line which supplies the video voltage to the sub pixel of first color of the second group and a video line which supplies the video voltage to the sub pixel of third color of the second group intersect with each other.

(14) In a liquid crystal display device including a liquid crystal display panel which has a first substrate, a second substrate, and a liquid crystal layer sandwiched between the first substrate and the second substrate, and a video line drive circuit, wherein the liquid crystal display panel includes a plurality of sub pixels arranged in a matrix array, and a plurality of video lines which supplies video voltages to the respective sub pixels of the plurality of sub pixels, each one of the plurality of sub pixels includes a pixel electrode and a counter electrode, and an electric field is generated between the pixel electrode and the counter electrode thus driving liquid crystal of the liquid crystal layer, wherein the plurality of sub pixels is divided into three sub pixels of a first group which are arranged in order of first color, second color and third color, and three sub pixels of a second group which are arranged in order of the third color, the second color and the first color, the three sub pixels of the first group and the three sub pixels of the second group are alternately arranged in the direction of the display line, the respective pixel electrodes of two neighboring sub pixels formed of the sub pixels of the same color arranged adjacent to each other along the direction of the display line are formed independently from each other, and the liquid crystal display device includes a selection circuit which connects respective three video lines which supply the video voltages to the three sub pixels of the first group and respective three video lines which supply the video voltages to the three sub pixels of the second group to corresponding terminals of the video line drive circuit.

To briefly explain advantageous effects acquired by typical inventions among the inventions disclosed in this specification, they are as follows.

The present invention can enhance a numerical aperture of the liquid crystal display device having color filters.

### BRIEF DESCRIPTION OF THE DRAWINGS

FIG. 1 is a plan view showing the arrangement of color filters of a liquid crystal display panel in an IPS-method all-transmissive-type liquid crystal display device of an embodiment 1 according to the present invention;

FIG. 2A and FIG. 2B are views showing the electrode structure of the liquid crystal display panel on a TFT substrate side of the embodiment 1 according to the present invention, wherein FIG. 2A is a plan view showing pixel electrodes and counter electrodes, and FIG. 2B is a plan view showing pixel electrodes, scanning lines and video lines;

FIG. 3 is a cross-sectional view taken along a line A-A′ in FIG. 1 showing the cross-sectional structure of the liquid crystal display panel of the embodiment 1 according to the present invention;

FIG. 4 is a plan view showing the electrode structure of a liquid crystal display panel on a TFT-substrate side in an IPS-method transflective-type liquid crystal display device of an embodiment 2 according to the present invention;

FIG. 5 is a cross-sectional view taken along a line B-B′ in FIG. 4 showing the cross-sectional structure of the liquid crystal display panel of the embodiment 2 according to the present invention;

FIG. 6 is a cross-sectional view taken along a line C-C′ in FIG. 4 showing the cross-sectional structure of the liquid crystal display panel of the embodiment 2 according to the present invention;

FIG. 7 is a cross-sectional view taken along a line D-D′ in FIG. 4 showing the cross-sectional structure of the liquid crystal display panel of the embodiment 2 according to the present invention;

FIG. 8A and FIG. 8B are views showing the electrode structure of a liquid crystal display panel on the TFT-substrate side in an IPS-method all-transmissive-type liquid crystal display device of an embodiment 3 according to the present invention;

FIG. 9 is a cross-sectional view taken along a line A-A′ in FIG. 1 showing the cross-sectional structure of the liquid crystal display panel of the embodiment 3 according to the present invention;

FIG. 10A and FIG. 10B are views showing the electrode structure of the liquid crystal display panel on the TFT-substrate side in an IPS-method all-transmissive-type liquid crystal display device as a modification of the embodiment 3 according to the present invention;

FIG. 11 is a plan view showing the electrode structure of a liquid crystal display panel on the TFT-substrate side in an vertical-electric-field-method (TN method, ECB method) all-transmissive-type liquid crystal display device of an embodiment 4 according to the present invention;

FIG. 12 is a cross-sectional view taken along a line A-A′ in FIG. 1 showing the cross-sectional structure of the liquid crystal display panel of the embodiment 4 according to the present invention;

FIG. 13 is a plan view showing the electrode structure of the liquid crystal display panel on the TFT-substrate side in an vertical-electric-field-method (TN method, ECB method) transflective-type liquid crystal display device of an embodiment 5 according to the present invention;

FIG. 14 is a cross-sectional view taken along a line E-E′ in FIG. 13 showing the cross-sectional structure of the liquid crystal display panel of the embodiment 5 according to the present invention;

FIG. 15 is a cross-sectional view taken along a line F-F′ in FIG. 13 showing the cross-sectional structure of the liquid crystal display panel of the embodiment 5 according to the present invention;

FIG. 16 is a cross-sectional view taken along a line G-G′ in FIG. 13 showing the cross-sectional structure of the liquid crystal display panel of the embodiment 5 according to the present invention;

FIG. 17 is a cross-sectional view taken along a line A-A′ in FIG. 1 showing the cross-sectional structure of a liquid crystal display panel in an vertical-electric-field-method (VA method) all-transmissive-type liquid crystal display device of an embodiment 6 according to the present invention;

FIG. 18 is a plan view showing the electrode structure of the liquid crystal display panel on the TFT-substrate side in an vertical-electric-field-method (VA method) transflective-type liquid crystal display device of an embodiment 7 according to the present invention;

FIG. 19 is a cross-sectional view taken along a line H-H′ in FIG. 18 showing the cross-sectional structure of the liquid crystal display panel of an embodiment 7 according to the present invention;

FIG. 20 is a cross-sectional view taken along a line I-I′ in FIG. 18 showing the cross-sectional structure of the liquid crystal display panel of the embodiment 7 according to the present invention;

FIG. 21 is a cross-sectional view taken along a line J-J′ in FIG. 18 showing the cross-sectional structure of the liquid crystal display panel of the embodiment 7 according to the present invention;

FIG. 22 is a plan view showing the arrangement of a color filter of a liquid crystal display panel in a liquid crystal display device of an embodiment 8 according to the present invention;

FIG. 23 is a plan view showing the arrangement of a color filter of a liquid crystal display panel in a liquid crystal display device of an embodiment 9 according to the present invention;

FIG. 24 is a plan view showing the arrangement of a color filter of a liquid crystal display panel in a liquid crystal display device of an embodiment 10 according to the present invention;

FIG. 25 is a cross-sectional view taken along a line A-A′ in FIG. 1 showing the cross-sectional structure of the liquid crystal display panel in a liquid crystal display device of an embodiment 11 according to the present invention;

FIG. 26 is a cross-sectional view taken along a line A-A′ in FIG. 1 showing the cross-sectional structure of a liquid crystal display panel in an IPS-method transmissive-type liquid crystal display device of an embodiment 12 according to the present invention;

FIG. 27 is a cross-sectional view taken along a line A-A′ in FIG. 1 showing the cross-sectional structure of a liquid crystal display panel in a liquid crystal display device of an embodiment 13 according to the present invention;

FIG. 28 is a first constitutional view relating to an output circuit of a video voltage in a liquid crystal display device of an embodiment 14 according to the present invention;

FIG. 29 is a second constitutional view relating to an output circuit of a video voltage in a liquid crystal display device of an embodiment 14 according to the present invention;

FIG. 30 is a constitutional view relating to an output circuit of a video voltage in a liquid crystal display device of an embodiment 15 according to the present invention;

FIG. 31 is a plan view showing the arrangement of a color filter of a liquid crystal display panel in a conventional liquid crystal display device;

FIG. 32 is a cross-sectional view taken along a line Z-Z′ in FIG. 31 showing the cross-sectional structure of the conventional liquid crystal display panel;

FIG. 33 is a cross-sectional view showing sizes of one example in FIG. 32; and

FIG. 34 is a constitutional view relating to an output circuit of a video voltage in the conventional liquid crystal display device.

### DESCRIPTION OF THE PREFERRED EMBODIMENTS

Hereinafter, the embodiments of the present invention are explained in detail in conjunction with drawings. Here, in all drawings for explaining the embodiments of the present invention, parts having identical functions are given same numerals and their repeated explanation is omitted.

A display method of an active-matrix-type liquid crystal display device can be classified into a vertical electric field method and a lateral electric field (IPS: In-Plane-Switching) method. The vertical electric field method can be further classified into a TN method, an OCB method, an ECB method, a VA method and the like depending on the difference in the initial orientation state. In the embodiment, an example in which the present invention is applied to the active-matrix-type liquid crystal display devices adopting these methods is explained.

Here, a minimum unit for displaying a letter or a graphic is referred to as a dot, and the dot constituting such a minimum unit is referred to as a pixel in a liquid crystal display.

Further, in a color display, the pixel is divided into portions of three colors consisting of red (R), green (G), blue (B), and the portions of three colors consisting of R, G, B are collectively referred to as the pixel, and one-third (⅓) dot obtained by dividing the pixel based on R, G, B is referred to as a sub pixel. In place of R, G, B, cyan, magenta and yellow may be used.

### Embodiment 1

In the embodiment 1, an example in which the present invention is applied to an IPS-method all-transmissive-type liquid crystal display device is explained.

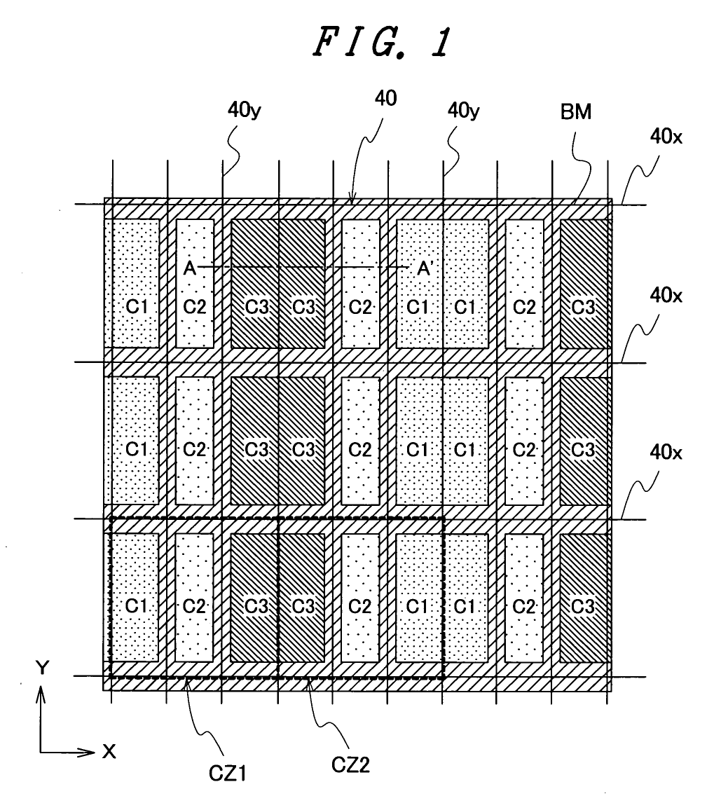

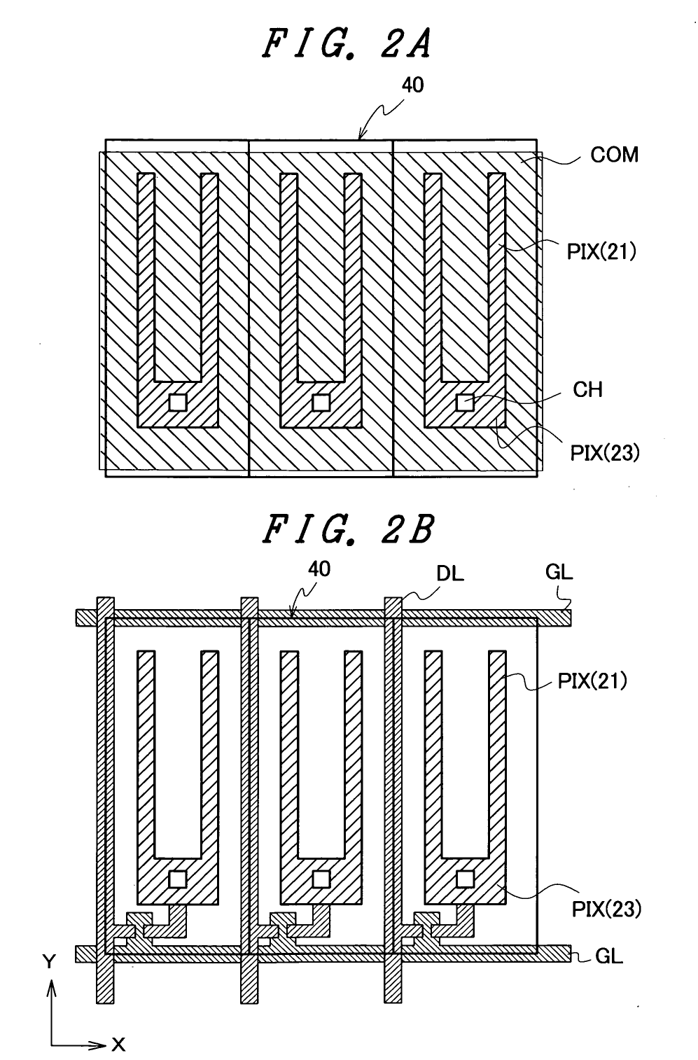

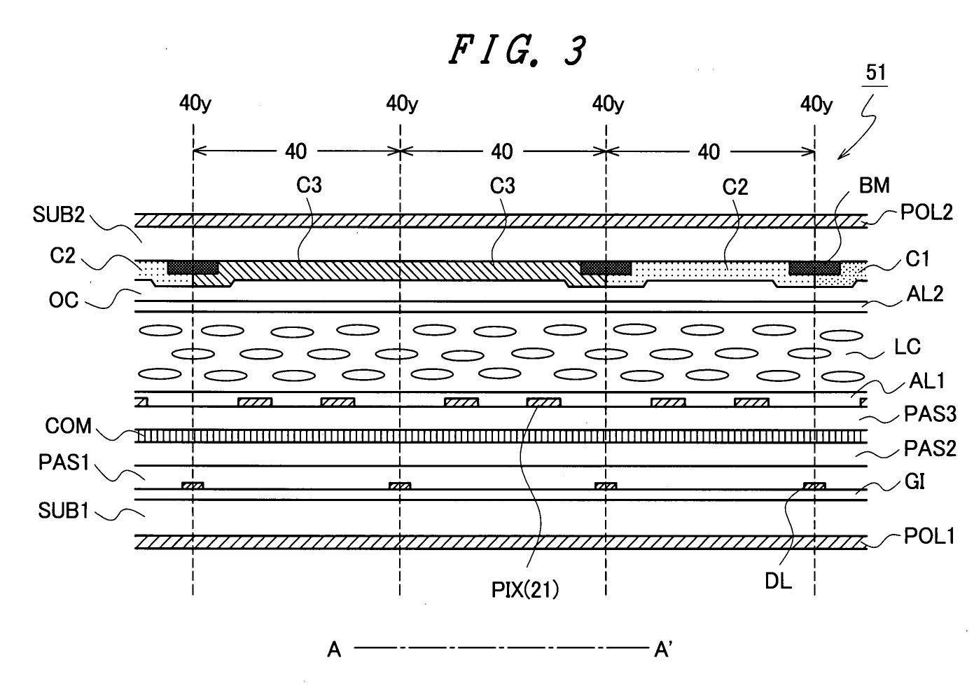

FIG. 1 to FIG. 3 are views showing the IPS-method all-transmissive-type liquid crystal display device according to the embodiment 1 of the present invention. Here, FIG. 1 is a plan view showing the arrangement of color filters of a liquid crystal display panel. FIG. 2A and FIG. 2B are views showing the electrode structure of the liquid crystal display panel on a TFT substrate side, wherein FIG. 2A is a plan view showing pixel electrodes and counter electrodes, and FIG. 2B is a plan view showing pixel electrodes, scanning lines and video lines. FIG. 3 is a cross-sectional view taken along a line A-A′ in FIG. 1 showing the cross-sectional structure of the liquid crystal display panel.

The IPS-method all-transmissive-type liquid crystal display device of the embodiment 1 includes a liquid crystal display panel 51 (see FIG. 3). The liquid crystal display panel 51 is, as shown in FIG. 3, configured such that a liquid crystal layer (LC) formed of a large number of liquid crystal molecules is sandwiched between a pair of glass substrates (SUB1, SUB2), and a main surface side of the glass substrate (SUB2) constitutes an observation side.

Further, the liquid crystal display panel 51 includes, as shown in FIG. 1, a plurality of sub pixels 40. Each one of the plurality of sub pixels 40 includes, as shown in FIG. 3, pixel electrodes (PIX) and a counter electrode (COM; also referred to as a common electrode). Each sub pixel 40 further includes any one of color filters consisting of a red (R) color filter C1, a green (G) color filter C2 and a blue (B) color filter C3.

Further, the liquid crystal display panel 51 includes, as viewed in a plan view, as shown in FIG. 2B, scanning lines (GL) which extend along the X direction, and video lines (DL) which extend along the Y direction orthogonal to the X direction in the same plane. The plurality of scanning lines (GL) is arranged at predetermined intervals in the Y direction, while the plurality of video lines (DL) is arranged at predetermined intervals in the X direction.

The plurality of sub pixels 40 is arranged in a matrix array in the X direction as well as in the Y direction, wherein the plurality of sub pixels 40 arranged along the X direction constitutes 1 display line, and the plurality of these 1 display lines is arranged in the y direction.

In FIG. 1, symbol 40y indicates a pixel boundary between the sub pixels 40 arranged adjacent to each other along the direction (X direction) of the display line. Symbol 40x indicates, assuming that two neighboring display lines are constituted of one display line and another display line, a pixel boundary between the sub pixel 40 of one display line and the sub pixel 40 of another display line, that is, a pixel boundary between the sub pixels 40 arranged adjacent to each other along the Y direction.

Here, the sub pixel 40 having the red color filter C1 may also be simply referred to as the red sub pixel 40, the sub pixel 40 having the green color filter C2 may also be simply referred to as the green sub pixel 40, and the sub pixel 40 having the blue color filter C3 may also be simply referred to as the blue sub pixel 40.

As shown in FIG. 3, on a liquid-crystal-layer (LC) side of the glass substrate (SUB2;.also referred to as a CF substrate), in order from the glass substrate (SUB2) toward the liquid crystal layer (LC), a light blocking film (BM; a black matrix), the red, green and blue color filters (C1, C2, C3), a protective film (OC), an orientation film (AL2) and the like are formed. On an outer side of the glass substrate (SUB2) opposite to the liquid-crystal-layer (LC) side, a polarizer (POL2) is arranged.

On a liquid-crystal-layer (LC) side of the glass substrate (SUB1; also referred to as a TFT substrate), in order from the glass substrate (SUB1) toward the liquid crystal layer (LC), the scanning lines (GL; also referred to as gate lines) (see FIG. 2B), a gate insulation film (GI), video lines (DL; also referred to as source lines or drain lines), an insulation film (PAS1), an insulation film (PAS2), the counter electrode (COM; also referred to as a common electrode), an insulation film (PAS3), the pixel electrodes (PIX), and an orientation film (AL1) are formed. On an outer side of the glass substrate (SUB1) opposite to the liquid crystal layer (LC) side, a polarizer (POL1) is arranged.

The pixel electrode (PIX) has, as shown in FIG. 2A and FIG. 2B, the comb-teeth electrode structure constituted of a connection portion 23 which extends along the extending direction (X direction) of the scanning line (GL), and a plurality of linear portions 21 each one of which extends in the extending direction of the video line (DL) from the connection portion 23 and is arranged at predetermined intervals along the extending direction of the scanning line (GL). The pixel electrode (PIX) of the embodiment 1 adopts the comb-teeth electrode structure having two linear portions 21, for example, although the pixel electrode (PIX) is not limited to such a structure.

Although in the embodiment 1, the linear portion 21 is explained as a portion of the pixel electrode (PIX), the linear portion (21) may be also referred to as a pixel electrode.

The counter electrode (COM) is formed in a divided manner for every 1 display line, for example, (although the division of the counter electrode not always being necessary), and the respective counter electrodes (COM) are formed in a planer shape.

The counter electrodes (COM) and the pixel electrodes (PIX) are, as shown in FIG. 3, stacked to each other by way of the insulation film (PAS3) thus forming a holding capacitance. In the embodiment 1, the pixel electrodes (PIX) are formed above the counter electrodes (COM). The counter electrodes (COM) and the pixel electrodes (PIX) are formed of a transparent conductive films made of ITO (Indium Tin Oxide) or the like, for example.

Here, the liquid crystal layer (LC) is made of positive liquid crystal or negative liquid crystal.

Further, a phase difference plate may be arranged between the polarizer (POL1, POL2) and the glass substrate (SUB1, SUB2).

Further, although the glass substrate is used as the substrate of the liquid crystal display panel 51 of the embodiment 1, it is sufficient for a material of the substrate to have the insulation property and hence, the material of the substrate is not limited to glass and may be plastic or the like.

Further, although not shown in the drawing, a backlight is arranged outside the polarizer (POL1) on the glass substrate (SUB1) side and hence, the liquid crystal display device functions as a transmissive-type liquid crystal display device. In this case, a main surface side of the glass substrate (SUB2) constitutes an observation side.

In the IPS-method all-transmissive-type liquid crystal display device of the embodiment 1, liquid crystal molecules of the liquid crystal layer (LC) can be re-arranged in plane by generating an electric field between the pixel electrode (PIX) and the counter electrode (COM). The phase difference of the liquid crystal layer (LC) is changed corresponding to the intensity of the electric field and hence, the phase of the linear polarized light which passes through the polarizer (POL1) on the glass substrate (SUB1) side can be changed in the liquid crystal layer (LC) thus enabling the selection between “passing” and “non-passing” of light through the polarizer (POL2) on the opposite side. As a result, contrast of light can be displayed on the observation surface side.

The arrangement of the sub pixels 40 (the arrangement of color filters) and the arrangement of the light blocking film (BM) are explained in conjunction with FIG. 1 and FIG. 3.

The plurality of sub pixels 40 adopts the arrangement in which two sub pixels 40 having the color filters of the same color are arranged adjacent to each other (close to each other) along the direction of the display line (X direction) in at least any one of three colors consisting of red, green and blue. That is, the plurality of sub pixels 40 is arranged such that two sub pixels 40 of the same color are arranged adjacent to each other (close to each other) along the direction of the display line in at least any one of three colors consisting of red, green and blue. In the embodiment 1, with respect to two colors consisting of red and blue, two sub pixels 40 of the same color are arranged adjacent to each other along the direction of the display line.

Such an arrangement can be satisfied by dividing the plurality of sub pixels 40 into a first group (first pixel) CZ1 in which three sub pixels 40 of red color (C1), green color (C2) and blue color (C3) are arranged in this order and a second group (second pixel) CZ2 in which three sub pixels 40 of blue color (C3), green color (C2) and red color (C1) are arranged in this order, and alternately arranging three sub pixels 40 of the first group (CZ1) and three sub pixels 40 of the second group (CZ2) in the direction of the display line (X direction) Here, two subpixels 40 of the same color arranged adjacent to each other along the direction of the display line (X direction) share the color filter in common. In the embodiment 1, with respect to two colors, that is, red and blue, two sub pixels 40 share the color filter (C1, C3) in common.

Further, the plurality of sub pixels 40, as shown in FIG. 2A and FIG. 2B, has the respective pixel electrodes (PIX) thereof made independent from each other, wherein two sub pixels 40 of the same color arranged adjacent to each other along the direction of the display line (X direction) also have the respective pixel electrodes (PIX) thereof made independent from each other.

The light blocking film (BM) is, as shown in FIG. 1 and FIG. 3, formed to cover respective pixel boundaries (40x, 40y) of the plurality of sub pixels 40 except for the pixel boundaries 40y each arranged between two sub pixels 40 of the same color which are arranged adjacent to each other along the direction of the display line (X direction). That is, the light blocking film (BM) is not formed on the pixel boundary 40y between two sub pixels 40 of the same color arranged adjacent to each other along the direction of the display line (X direction).

Since there is no possibility of occurrence of color mixing when the respective color filters of two sub pixels 40 arranged adjacent to each other along the direction of the display line (X direction), it is unnecessary to form the light blocking film (BM) on the pixel boundary 40y between these two sub pixels 40. By making the light blocking film (BM) unnecessary, a numerical aperture can be enhanced. In the embodiment 1, with respect to two colors, that is, red and blue, two sub pixels 40 are arranged adjacent to each other along the direction of the display line (X direction), and no light blocking film (BM) is formed on the pixel boundary 40y between these sub pixels 40 and hence, a numerical aperture can be enhanced.

Along with the enhancement of the numerical aperture, the transmissivity of the liquid crystal display panel 51 can be enhanced. Provided that the brightness of the backlight is fixed, the display brightness can be enhanced along with the enhancement of the numerical aperture thus giving rise to an advantageous effect that the display quality is enhanced. Further, to acquire the same display brightness, the brightness of the backlight can be lowered by enhancing the numerical aperture thus reducing the power consumption of the backlight.

Here, in the embodiment 1, the explanation has been made with respect to the example in which two sub pixels 40 in two colors, that is, red and blue, out of three colors consisting of red, green and blue, are arranged adjacent to each other along the direction of the display line. However, the present invention is not limited to such an example. For example, two colors may be constituted of red and green or green and blue.

Further, the color of sub pixel may be any one of three colors of red, green and blue. In this case, for example, this arrangement condition maybe satisfied by dividing the plurality of sub pixels 40 into the first group (first pixel) CZ1 in which three sub pixels 40 of red color (C1), green color (C2) and blue color (C3) are arranged in this order and the second group (second pixel) CZ2 in which three sub pixels 40 of blue color (C3), red color (C1), and green color (C2) are arranged in this order, and alternately arranging three sub pixels 40 of the first group (CZ1) and three sub pixels 40 of the second group (CZ2) in the direction of the display line (X direction). However, the use of one color lowers the numerical aperture compared to the case of using two colors.

Here, in the embodiment 1, the plurality of sub pixels 40 is arranged in a state that the sub pixels 40 of the same color are arranged adjacent to each other between two neighboring display lines. That is, the plurality of sub pixels 40 is arranged in a state that, assuming that two neighboring display lines are constituted of one display line and another display line, the sub pixel 40 on one display line and the sub pixel 40 on another display line are of the same color and are arranged adjacent to each other.

Here, the above-mentioned patent document 1 (JP-A-11-84365), patent document 2 (JP-A-2002-107709), and patent document 3 (JP-A-2005-62220) describe the arrangement of sub pixels in which the sub pixels are arranged in order of colors R, G, B, B, G and R.

However, the above-mentioned respective patent documents fail to disclose the above-mentioned arrangement of sub pixels of the embodiment in which numerical aperture can be enhanced by eliminating the formation of a light blocking film (BM) on a pixel boundary 40y between two sub pixels of the same color arranged adjacent to each other along the direction of the display line (X direction).

### Embodiment 2

In the embodiment 2, the explanation is made with respect to an example in which the present invention is applied to an IPS-method transflective-type liquid crystal display device.

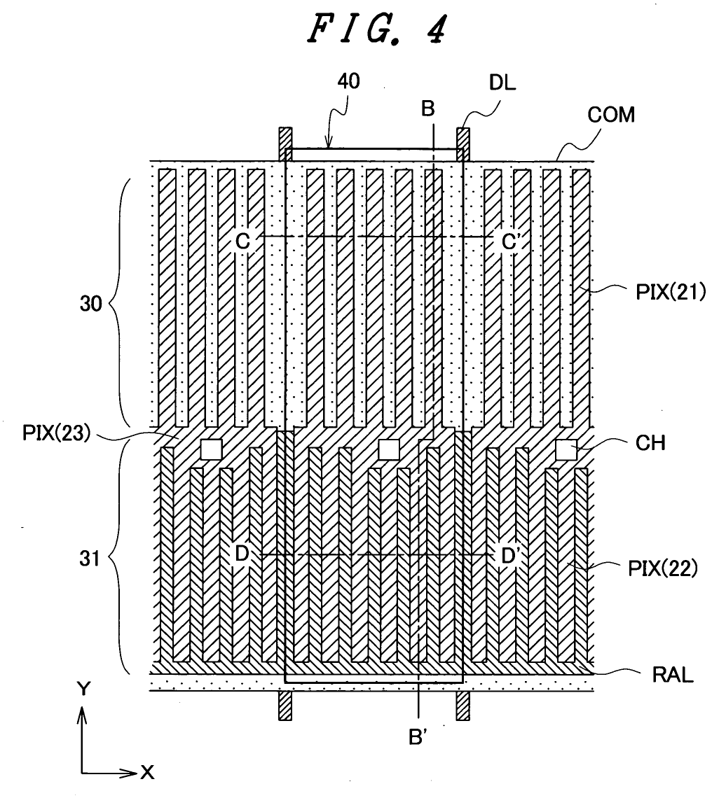

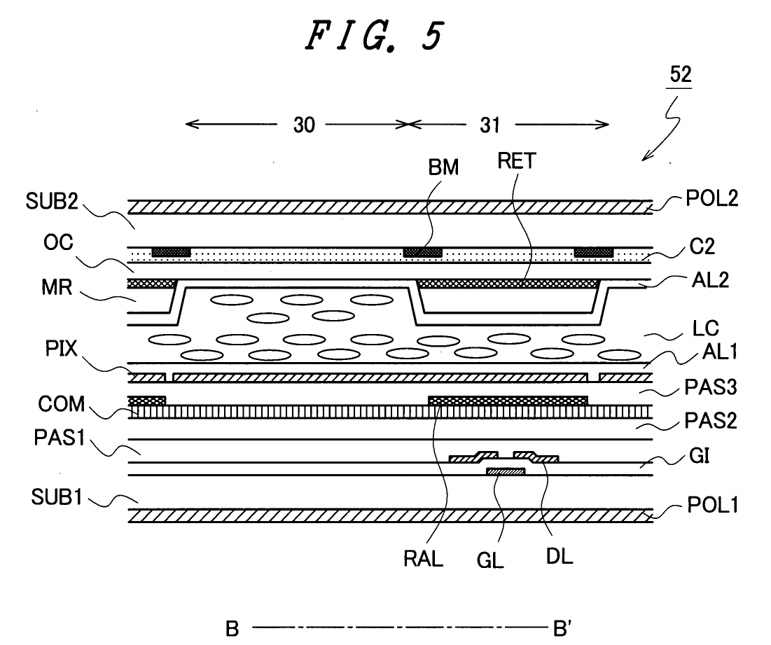

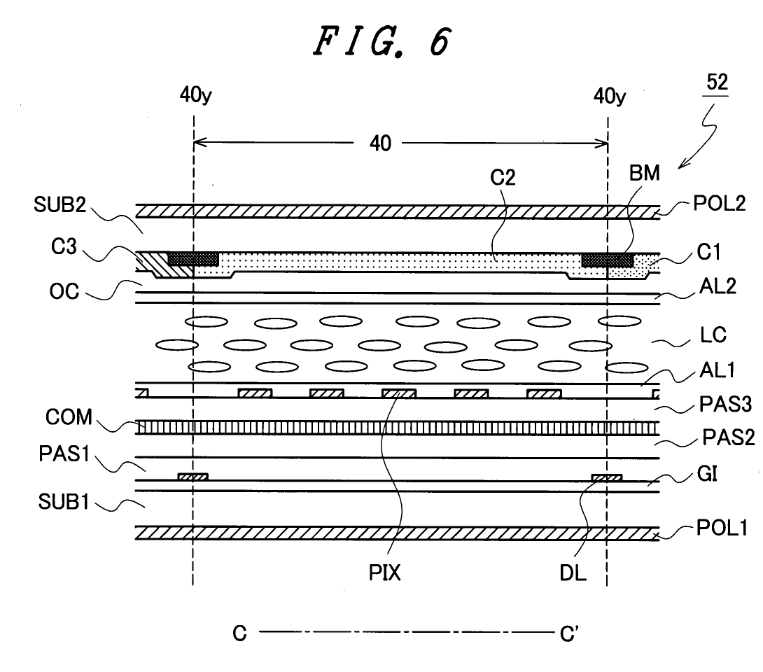

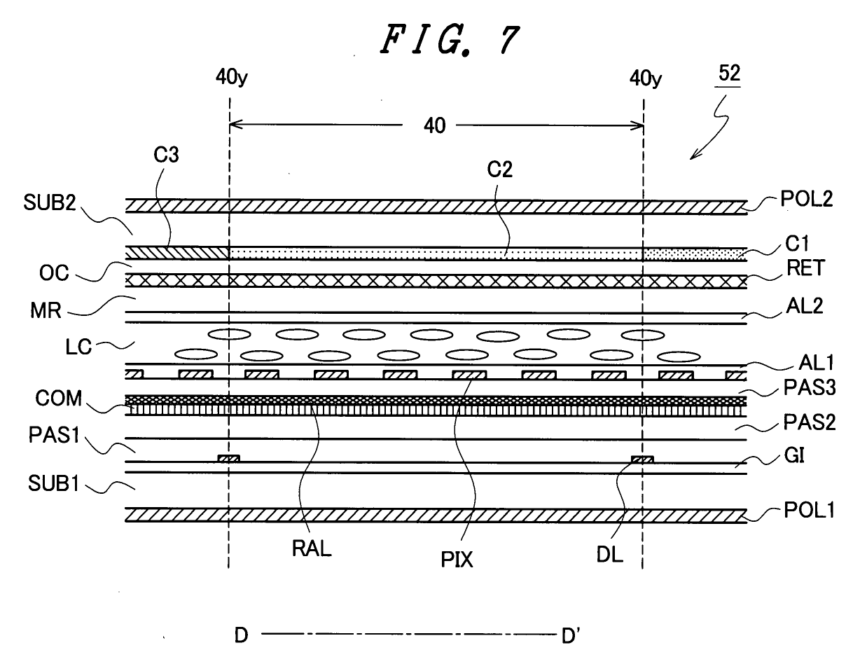

FIG. 4 to FIG. 7 are views showing the IPS-method transflective-type liquid crystal display device according to the embodiment 2 of the present invention. Here, FIG. 4 is a plan view showing the electrode structure of a liquid crystal display panel on a TFT substrate side, FIG. 5 is a cross-sectional view taken along a line B-B′ in FIG. 4 showing the cross-sectional structure of the liquid crystal display panel, FIG. 6 is a cross-sectional view taken along a line C-C′ in FIG. 4 showing the cross-sectional structure of the liquid crystal display panel, and FIG. 7 is a cross-sectional view taken along a line D-D′ in FIG. 4 showing the cross-sectional structure of the liquid crystal display panel.

Here, in FIG. 4 and FIG. 5, numeral 30 indicates a transmissive portion which constitutes a transmissive-type liquid crystal display panel, and numeral 31 indicates a reflective portion which constitutes a reflection-type liquid crystal display panel. Further, in FIG. 5 to FIG. 7, numeral 52 indicates a liquid crystal display panel. Further, FIG. 5 shows the cross-sectional structures of the transmissive portion 30 and the cross-sectional structures of reflective portion 31, FIG. 6 shows the cross-sectional structure of the transmissive portion 30, and FIG. 7 shows the cross-sectional structure of the reflective portion 31.

The IPS-method transflective-type liquid crystal display device of the embodiment 2 is characterized by adding a reflection display function to the constitution of the embodiment 1 described above and includes both of the transmissive portion 30 and the reflective portion 31 in 1 sub pixel 40. That is, in the liquid crystal display panel 52 of the embodiment 2, each one of the plurality of sub pixels 40 includes the transmissive portion 30 and the reflective portion 31. The constitution is generally called as the transflective-type liquid crystal display panel. In this case, the transmissive portion 30 has the same constitution as the constitution of the transmissive portion 30 of the embodiment 1, while the constitution of the reflective portion 31 differs from the constitution of the transmissive portion 30 of the embodiment 1.

The reflective portion 31 includes a reflection electrode (RAL) (reflector) made of aluminum alloy or the like in the inside of a cell (in the inside of 1 sub pixel). The reflection electrodes (RAL) have a function of reflecting light incident from an observation surface. Further, it is necessary to allow circularly polarized light to be incident on the inside of the liquid crystal cell for performing a reflection display and hence, a phase difference film (RET) is arranged between a polarizer (POL2) and the reflection electrode (RAL). In the embodiment 2, the built-in phase difference film (RET) is formed only on the reflective portion 31, and the reflective portion 31 is constituted of the polarizer (POL2), the phase difference film (RET) corresponding to a half-waveplate, the liquid crystal, and the reflection electrode (RAL) in this order from the polarizer (POL2) side, wherein the half-waveplate and the liquid crystal form a broad-band quarter-wave plate. Accordingly, it is necessary to provide the liquid crystal layer (LC) corresponding to the quarter-wave plate.

Since the transmissive portion 30 usually corresponds to a half-wave plate, it is necessary to change the retardation between the transmissive portion 30 and the reflective portion 31. The change of retardation can be realized by setting a cell gap length of the reflective portion 31 to a value approximately one half of the transmissive portion 30. The difference in cell gap length between the reflective portion 31 and the transmissive portion 30 can be realized by providing a stepped-portion forming layer (MR) on the reflective portion 31.

The reflection electrode (RAL) is arranged on the counter electrode (COM) in the reflective portion 31.

The pixel electrode (PIX) of the embodiment 2 includes, as shown in FIG. 4, a connection portion 23 arranged on a boundary portion between the transmissive portion 30 and the reflective portion 31, a plurality of linear portions 21 arranged in the transmissive portion 30 and having respective one-end-sides thereof connected with the connection portion 23, and a plurality of linear portions 22 arranged in the reflective portion 31 and having one-end-sides thereof connected with the connection portion 23. The connection portion 23 extends along the extending direction (X direction) of the scanning line (GL). The plurality of linear portions 21 is pulled out toward the transmissive portion 30 side along the extending direction (Y direction) of the video line (DL) from the connection portion 23 and is arranged at predetermined intervals along the extending direction of the scanning line (GL). The plurality of linear portions 22 is pulled out toward the reflective portion 31 side along the extending direction (Y direction) of the video line (DL) from the connection portion 23 and is arranged at predetermined intervals along the extending direction (X direction) of the scanning line (GL). In the pixel electrode (PIX) of the embodiment 2, the transmissive portion 30 and the reflective portion 31 differ from each other in the number of the linear portions (21, 22). That is, for example, five linear portions 21 are arranged in the transmissive portion 30, while for example, six linear portions 22 are arranged in the reflective portion 31.

The IPS-method transflective-type liquid crystal display device of the embodiment 2 can also perform the reflection display in addition to the transmission display.

Here, the plurality of sub pixels 40 are arranged, in the same manner as the above-mentioned embodiment 1, two sub pixels 40 in two colors, that is, red and blue, out of three colors consisting of red, green and blue, are arranged adjacent to each other along the direction of the display line (X direction) and includes two sub pixels 40 having the color filters of the same color (see FIG. 1). These two sub pixels 40 of the same color share the color filter in common.

Further, the plurality of subpixels 40, in the same manner as the constitution described with the embodiment 1, has the respective pixel electrodes (PIX) thereof made independent from each other, wherein two sub pixels 40 of the same color arranged adjacent to each other along the direction of the display line (X direction) also have the respective pixel electrodes (PIX) made independent from each other (see FIG. 4).

Further, the light blocking film (BM) is, in the same manner as the constitution described with respect to the embodiment 1, formed to cover respective pixel boundaries (40x, 40y) of the plurality of sub pixels 40 except for the pixel boundaries 40y each arranged between two sub pixels 40 of the same color which are arranged adjacent to each other along the direction of the display line (X direction) (see FIG. 1).

The IPS-method transflective-type liquid crystal display device of the embodiment 2 constituted in this manner can also acquire the manner of operation and the advantageous effects described above.

Here, in place of using the built-in phase difference film (RET), an externally-mounted phase difference film may be used.

### Embodiment 3

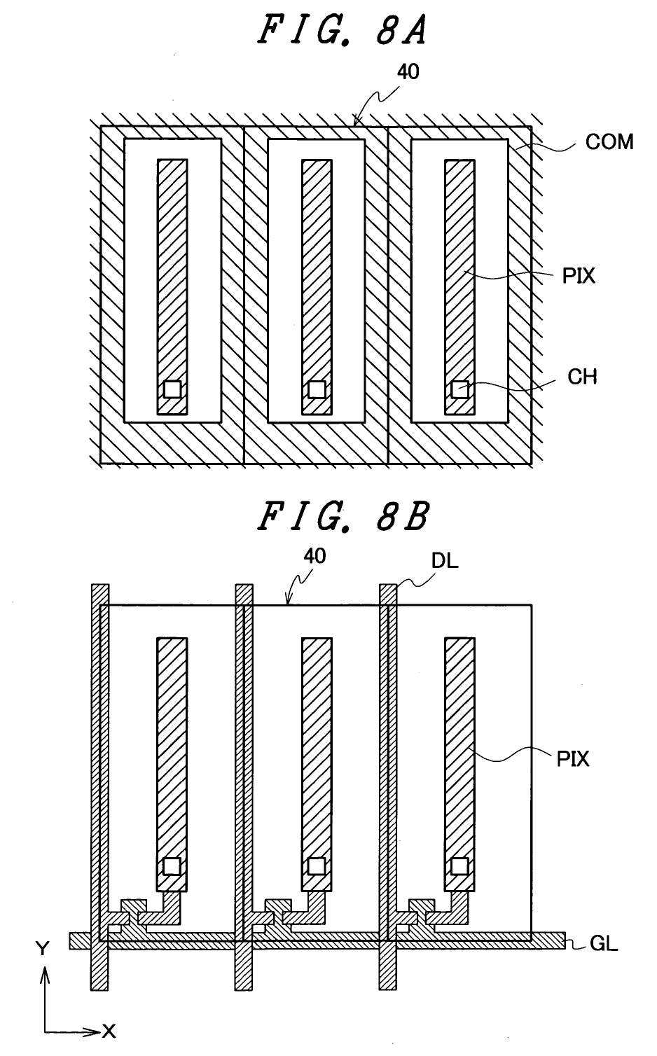

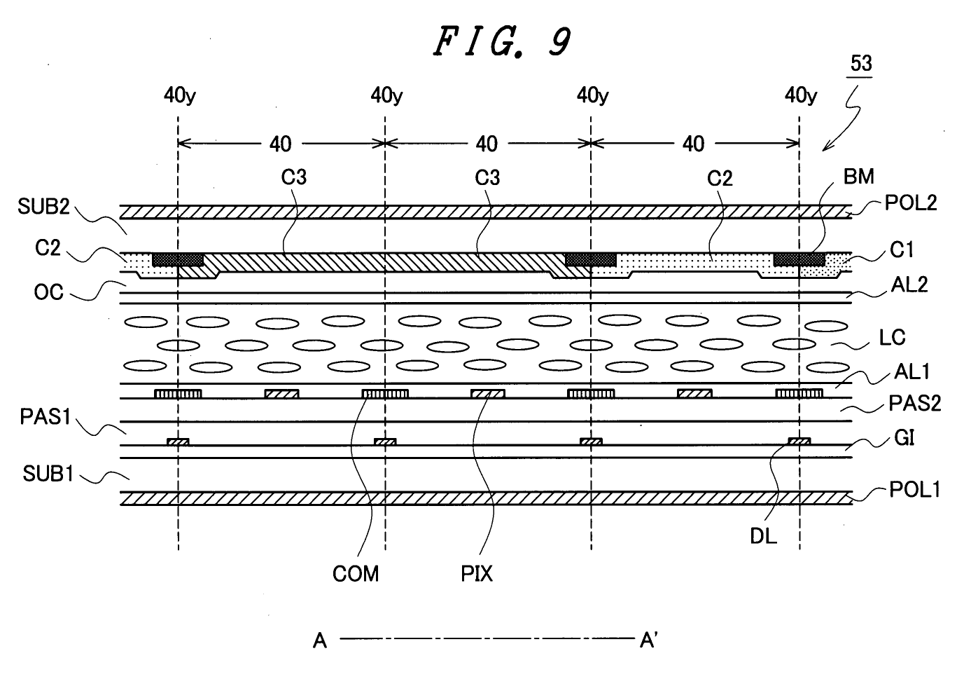

FIG. 8A, FIG. 8B and FIG. 9 are views showing an IPS-method all-transmissive-type liquid crystal display device of the embodiment 3 according to the present invention. FIG. 8A and FIG. 8B are views showing the electrode structure of a liquid crystal display panel on a TFT substrate side, wherein FIG. 8A is a plan view showing pixel electrodes and counter electrodes, and FIG. 8B is a plan view showing the pixel electrodes, scanning lines and video lines). FIG. 9 is a cross-sectional view taken along a line A-A′ in FIG. 1 showing the cross-sectional structure of the liquid crystal display panel.

The IPS-method all-transmissive-type liquid crystal display device of the embodiment 3 includes the liquid crystal display panel 53 (see FIG. 9). The liquid crystal display panel 53 is, as shown in FIG. 9, configured such that a liquid crystal layer (LC) formed of a large number of liquid crystal molecules is sandwiched between a pair of glass substrates (SUB1, SUB2), and a main surface side of the glass substrate (SUB2) constitutes an observation side.

Further, the liquid crystal display panel 53 includes, as shown in FIG. 1, a plurality of sub pixels 40. Each one of the plurality of sub pixels 40 includes, as shown in FIG. 9, a pixel electrode (PIX) and a counter electrode (COM; also referred to as a common electrode). Each sub pixel 40 further includes any one of color filters consisting of a red (R) color filter C1, a green (G) color filter C2 and a blue (B) color filter C3.

Further, the liquid crystal display panel 53 includes, as viewed in a plan view, as shown in FIG. 8B, the scanning lines (GL) which extend along the X direction, and the video lines (DL) which extend along the Y direction orthogonal to the X direction in the same plane. The plurality of scanning lines (GL) is arranged at predetermined intervals in the Y direction, while the plurality of video lines (DL) is arranged at predetermined intervals in the X direction.

As shown in FIG. 9, on the liquid-crystal-layer (LC) side of the glass substrate (SUB2; also referred to as a CF substrate), in order from the glass substrate (SUB2) toward the liquid crystal layer (LC), a light blocking film (BM; black matrix), the red, green and blue color filters (C1, C2, C3), a protective film (OC), cell gap forming projection bodies (not shown in the drawing), an orientation film (AL2) and the like are formed. On an outer side of the glass substrate (SUB2) opposite to a liquid-crystal-layer (LC) side, a polarizer (POL2) is arranged.

On a liquid-crystal-layer (LC) side of the glass substrate (SUB1; also referred to as a TFT substrate), in order from the glass substrate (SUB1) toward the liquid crystal layer (LC), the scanning lines (GL; also referred to as gate lines) (see FIG. 8B), a gate insulation film (GI), video lines (DL; also referred to as source lines or drain lines), an insulation film (PAS1), an insulation film (PAS2), the counter electrodes (COM), the pixel electrodes (PIX) and an orientation film (AL1) are formed. On an outer side of the glass substrate (SUB1) opposite to the liquid crystal layer (LC) side, a polarizer (POL1) is arranged.

The counter electrodes (COM) and the pixel electrodes (PIX) are, as shown in FIG. 9, arranged to face each other in an opposed manner in the planar direction, that is, are formed on the same layer in the planar direction.

As shown in FIG. 8A and FIG. 8B, the pixel electrode (PIX) has the linear structure constituted of one line extending along the extending direction of the video line (DL). A plurality of through hole regions is formed in the counter electrode (COM) corresponding to the respective sub pixels 40, and the pixel electrodes (PIX) are arranged in the respective through hole regions.

The liquid crystal layer (LC) is made of positive liquid crystal or negative liquid crystal.

Further, it may be possible to arrange a phase difference plate between the polarizer (POL1) and the glass substrate (SUB1) as well as between the polarizer (POL2) and the glass substrate (SUB2).

Further, although not shown in the drawing, a backlight is arranged outside the polarizer (POL1) on the glass substrate (SUB1) side and hence, the liquid crystal display device functions as a transmissive-type liquid crystal display device. In this case, a main surface side of the glass substrate (SUB2) constitutes an observation side.

In the IPS-method all-transmissive-type liquid crystal display device of the embodiment 3, liquid crystal molecules can be re-arranged in plane by applying an electric field between the pixel electrode (PIX) and the counter electrode (COM). The phase difference of the liquid crystal layer (LC) is changed corresponding to the intensity of the electric field and hence, a phase of the linear polarized light which passes through the polarizer (POL1) on the glass substrate (SUB1) side can be changed in the liquid crystal layer (LC) thus enabling the selection between “passing” and “non-passing” of light through the polarizer (POL2) on the opposite side. As a result, contrast of light can be displayed on the observation surface side.

Here, the plurality of sub pixels 40 are arranged, in the same manner as the above-mentioned embodiment 1, wherein two sub pixels 40 in two colors, that is, red and blue, out of three colors consisting of red, green and blue, are arranged adjacent to each other along the direction of the display line (X direction), and the plurality of sub pixels 40 includes two sub pixels 40 having the color filters of the same color (see FIG. 1). These two sub pixels 40 of the same color share the color filter in common.

Further, the plurality of sub pixels 40, in the same manner as the constitution described with respect to the embodiment 1, has the respective pixel electrodes (PIX) thereof made independent from each other, wherein two sub pixels 40 of the same color arranged adjacent to each other along the direction of the display line (X direction) also have the respective pixel electrodes (PIX) thereof made independent from each other (see FIG. 8A and FIG. 8B).

Further, the light blocking film (BM) is, in the same manner as the constitution described with respect to the embodiment 1, formed to cover respective pixel boundaries (40x, 40y) of the plurality of sub pixels 40 except for the pixel boundaries 40y each arranged between two sub pixels 40 of the same color which are arranged adjacent to each other along the direction of the display line (X direction) (see FIG. 1).

The IPS-method all-transmissive-type liquid crystal display device of the embodiment 3 constituted in this manner can also acquire the manner of operation and the advantageous effects described above.

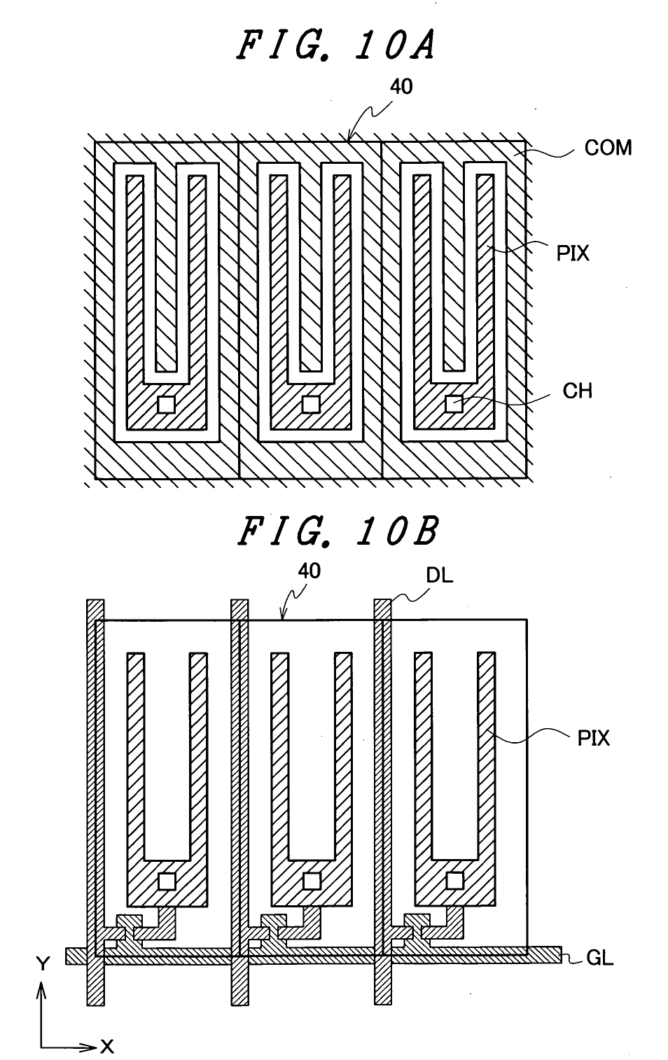

FIG. 10A and FIG. 10B are views showing the electrode structure of the liquid crystal display panel on the TFT substrate side in an IPS-method all-transmissive-type liquid crystal display device of a modification of the embodiment 3 according to the present invention, wherein FIG. 10A is a plan view showing the pixel electrodes and the counter electrodes, and FIG. 10B is a plan view showing the pixel electrodes, the scanning lines and the video lines).

In this modification, the pixel electrode (PIX) adopts the same comb-teeth electrode structure as the pixel electrode (PIX) described in the embodiment 1. The liquid crystal display device of this modification can also acquire the manner of operation and the advantageous effects described above. Here, the liquid crystal display panel of this modification may be formed into a transflective-type liquid crystal display panel by adding a reflection display function in the same manner as the liquid crystal display panel of the embodiment 2.

### Embodiment 4

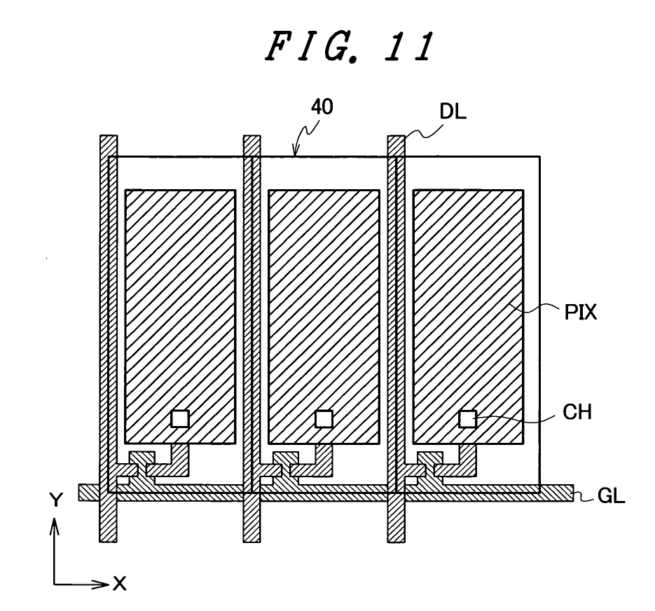

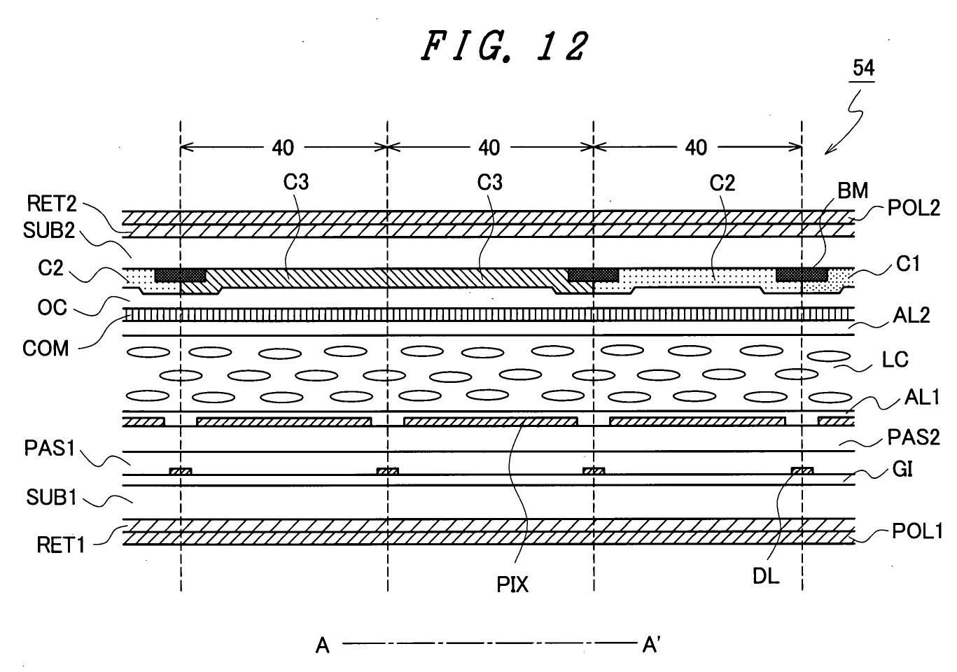

FIG. 11 and FIG. 12 are views showing a vertical-electric-field-method (TN method, ECB method) all-transmissive-type liquid crystal display device of the embodiment 4 according to the present invention. FIG. 11 is a plan view showing the electrode structure of the liquid crystal display panel on the TFT-substrate side, and FIG. 12 is a cross-sectional view taken along a line A-A′ in FIG. 1 showing the cross-sectional structure of the liquid crystal display panel.

The vertical-electric-field-method all-transmissive-type liquid crystal display device of the embodiment 4 includes a liquid crystal display panel 54 (see FIG. 12). The liquid crystal display panel 54 is, as shown in FIG. 12, configured such that a liquid crystal layer (LC) formed of a large number of liquid crystal molecules is sandwiched between a pair of glass substrates (SUB1, SUB2), and a main surface side of the glass substrate (SUB2) constitutes an observation side.

Further, as shown in FIG. 11, the liquid crystal display panel 54 includes a plurality of sub pixels 40. Each one of the plurality of sub pixels 40 includes, as shown in FIG. 12, a pixel electrode (PIX) and a counter electrode (COM; also referred to as a common electrode). Each sub pixel 40 further includes any one of color filters consisting of a red (R) color filter C1, a green (G) color filter C2 and a blue (B) color filter C3.

Further, the liquid crystal display panel 54 includes, as viewed in a plan view, as shown in FIG. 11, the scanning lines (GL) which extend along the X direction, and the video lines (DL) which extend along the Y direction orthogonal to the X direction in the same plane. The plurality of scanning lines (GL) is arranged at predetermined intervals in the Y direction, while the plurality of video lines (DL) is arranged at predetermined intervals in the X direction.

As shown in FIG. 12, on the liquid-crystal-layer (LC) side of the glass substrate (SUB2; also referred to as a CF substrate), in order from the glass substrate (SUB2) toward the liquid crystal layer (LC), a light blocking film (BM; black matrix), the red, green and blue color filters (C1, C2, C3), a protective film (OC), the counter electrodes (COM), cell gap forming projection bodies (not shown in the drawing), an orientation film (AL2) and the like are formed. On an outer side of the glass substrate (SUB2) opposite to the liquid-crystal-layer (LC) side, a polarizer (POL2) is arranged.

On a liquid-crystal-layer (LC) side of the glass substrate (SUB1; also referred to as a TFT substrate), in order from the glass substrate (SUB1) toward the liquid crystal layer (LC), the scanning lines (GL; also referred to as gate lines) (see FIG. 11), a gate insulation film (GI), video lines (DL; also referred to as source lines or drain lines), an insulation film (PAS1), an insulation film (PAS2), the pixel electrodes (PIX), an orientation film (AL1) and the like are formed. On an outer side of the glass substrate (SUB1) opposite to the liquid crystal layer (LC) side, a polarizer (POL1) is arranged.

Here, the liquid crystal layer (LC) is made of positive liquid crystal.

Further, it may be possible to arrange phase difference plates (RET1, RET2) between the polarizer (POL1) and the glass substrate (SUB1) as well as between the polarizer (POL2) and the glass substrate (SUB2).

Further, although not shown in the drawing, a backlight is arranged outside the polarizer (POL1) on the glass substrate (SUB1) side and hence, the liquid crystal display device functions as a transmissive-type liquid crystal display device. In this case, a main surface side of the glass substrate (SUB2) constitutes an observation side.

In the liquid crystal display device having such a constitution, by applying an electric field between the pixel electrodes PIX and the counter electrodes (COM) formed on the glass substrate (SUB2) side, it is possible to re-arrange the liquid crystal molecules horizontally as well as vertically with respect to the substrate. A rotatory polarization state of light or the phase difference of the liquid crystal layer (LC) is changed corresponding to the intensity of an electric field and hence, the rotatory polarization state or phase of the linear polarized light which passes through the polarizer (POL1) on the glass substrate (SUB1) side can be changed in the liquid crystal layer (LC) thus enabling the selection between “passing” and “non-passing” of light through the polarizer (POL2) on the opposite side. As a result, the contrast of light can be displayed on the observation surface side.

Here, the light blocking film (BM) is, in the same manner as the above-described embodiment 1, as shown in FIG. 1 and FIG. 12, formed to cover respective pixel boundaries (40x, 40y) of the plurality of sub pixels 40 except for the pixel boundaries 40y each arranged between two sub pixels 40 of the same color which are arranged adjacent to each other along the direction of the display line (X direction). That is, the light blocking film (BM) is not formed on the pixel boundary 40y between two sub pixels 40 of the same color arranged adjacent to each other along the direction of the display line (X direction) and hence, a numerical aperture can be enhanced. Along with the enhancement of the numerical aperture, the transmissivity of the liquid crystal display panel can be enhanced. Provided that the brightness of the backlight is fixed, the display brightness can be increased along with the enhancement of the numerical aperture thus giving rise to an advantageous effect that the display quality is enhanced. Further, to acquire the same display brightness, the brightness of the backlight can be lowered by enhancing the numerical aperture thus reducing the power consumption of the backlight.

### Embodiment 5

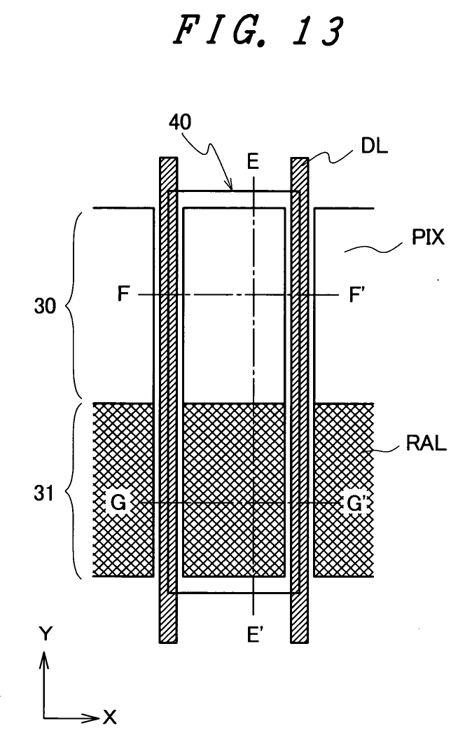

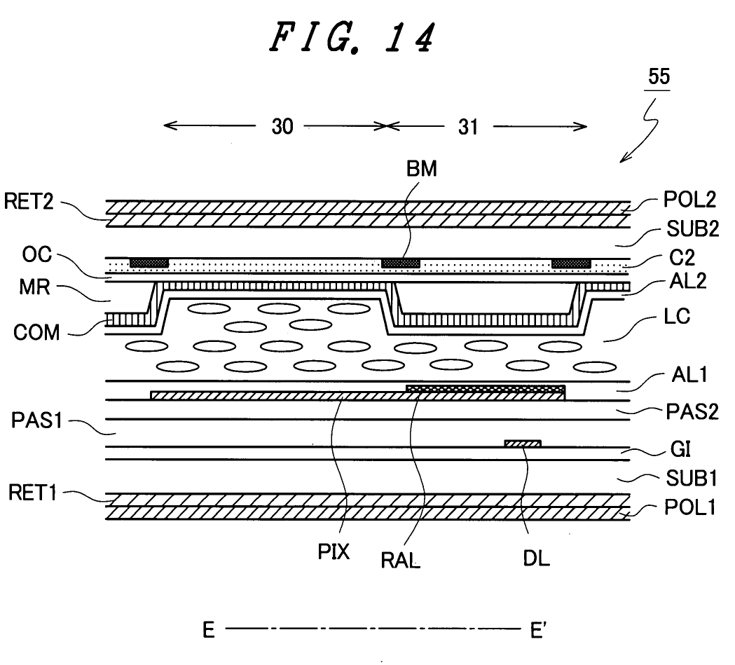

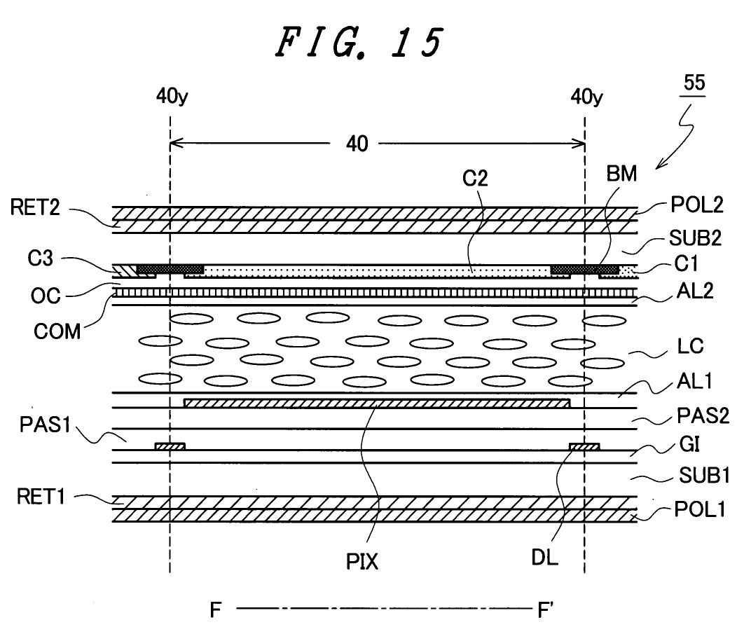

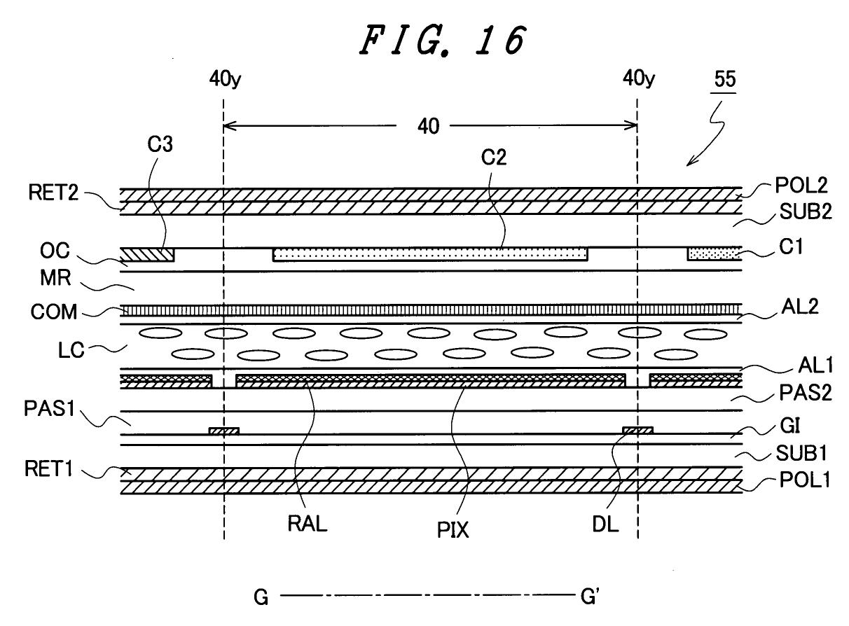

FIG. 13 to FIG. 16 are views showing a vertical-electric-field method (TN method, ECB method) transflective-type liquid crystal display device of the embodiment 5 according to the present invention. FIG. 13 is a plan view showing the electrode structure of the liquid crystal display panel on the TFT-substrate side, FIG. 14 is a cross-sectional view taken along a line E-E′ in FIG. 13 showing the cross-sectional structure of the liquid crystal display panel, FIG. 15 is a cross-sectional view taken along a line F-F′ in FIG. 13 showing the cross-sectional structure of the liquid crystal display panel, and FIG. 16 is a cross-sectional view taken along a line G-G′ in FIG. 13 showing the cross-sectional structure of the liquid crystal display panel.

Here, in FIG. 13 and FIG. 14, numeral 30 indicates a transmissive portion which constitutes a transmissive-type liquid crystal display panel, and numeral 31 indicates a reflective portion which constitutes a reflection-type liquid crystal display panel. Further, in FIG. 14 to FIG. 16, numeral 55 indicates a liquid crystal display panel. Further, FIG. 14 shows the cross-sectional structure of the transmissive portion 30 and the cross-sectional structure of the reflective portion 31, FIG. 15 shows the cross-sectional structure of the transmissive portion 30, and FIG. 16 shows the cross-sectional structure of the reflective portion 31.

The liquid crystal display device of the embodiment 5 is characterized by adding a reflection display function to the constitution of the embodiment 4, and includes both of the transmissive portion 30 and the reflective portion 31 in 1 sub pixel. The constitution is generally called as the transflective-type liquid crystal display panel. In this case, the transmissive portion 30 of this embodiment 5 has the same constitution as the constitution of the transmissive portion 30 of the embodiment 4, while the constitution of the reflective portion 31 differs from the constitution of the transmissive portion 30 of the embodiment 4.

The reflective portion 31 includes a reflection electrode (RAL) made of aluminum alloy in the inside of a cell (in the inside of 1 sub pixel), and the reflection electrode (RAL) has a function of reflecting light incident from the observation surface. Further, it is necessary to allow circularly polarized light to be incident in the inside of the liquid crystal cell for the reflection display and hence, phase difference plates (RET1, RET2) are arranged between the polarizers (POL1, POL2) and the reflection electrode (RAL). The phase difference plates (RET1, RET2) are usually formed of a quarter-wave plate respectively. A broad-band quarter-wave plate may be constituted by stacking a plurality of phase difference plates (RET1, RET2).

The liquid crystal layer (LC) of the transmissive portion 30 usually corresponds to a half-wave plate and the liquid crystal layer (LC) of the reflective portion 31 usually corresponds to-a quarter-wave plate and hence, it is necessary to change the retardation between the transmissive portion 30 and the reflective portion 31. The change of retardation can be realized by setting a cell gap length of the reflective portion 31 to a value approximately half of the transmissive portion 30.

This constitution enables the liquid crystal display panel to perform a reflection display in addition to the transmission display. Further, the light blocking film (BM) is not arranged between color filters of the same color arranged adjacent to each other between the subpixels 40 (a pixel boundary 40y between two sub pixels 40 of the same color arranged adjacent to each other along the direction of the display line (X direction)) and hence, a numerical aperture is enhanced. Along with the enhancement of the numerical aperture, the transmissivity of the liquid crystal display panel can be enhanced. Provided that the brightness of the backlight is fixed, the display brightness can be increased along with the enhancement of the numerical aperture thus giving rise to an advantageous effect that the display quality is enhanced. Further, to acquire the same display brightness, the brightness of the backlight can be lowered by enhancing the numerical aperture thus reducing the power consumption of the backlight.

### Embodiment 6

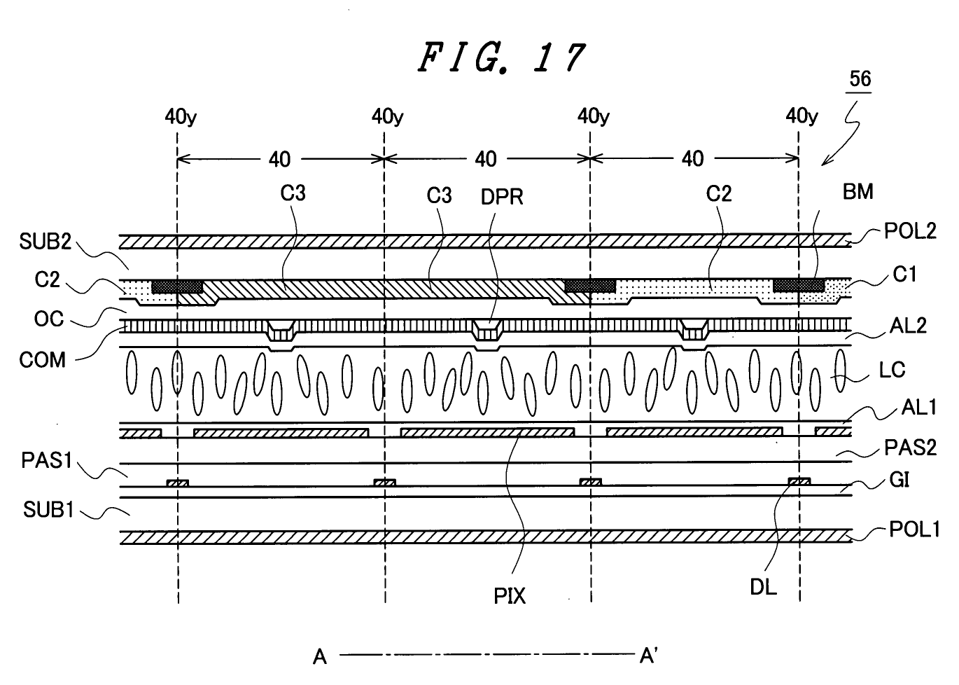

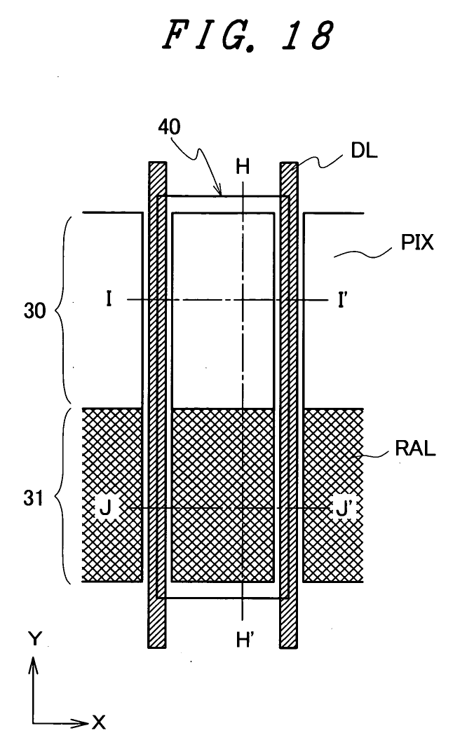

FIG. 17 is a cross-sectional view taken along a line A-A′ in FIG. 1 showing the cross-sectional structure of a liquid crystal display panel in an vertical-electric-field-method (VA method) all-transmissive-type liquid crystal display device of the embodiment 6 according to the present invention.

The all-transmissive-type liquid crystal display device of a vertical-electric-field-method of the embodiment 6 according to the present invention includes a liquid crystal display panel 56 (see FIG. 17). The liquid crystal display panel 56 is, as shown in FIG. 17, configured such that a liquid crystal layer (LC) formed of a large number of liquid crystal molecules is sandwiched between a pair of glass substrates (SUB1, SUB2), and a main surface side of the glass substrate (SUB2) constitutes an observation side.

On a liquid-crystal-layer (LC) side of the glass substrate (SUB2; also referred to as a CF substrate), in order from the glass substrate (SUB2) toward the liquid crystal layer (LC), a light blocking film (BM; a black matrix), red, green and blue color filters (C1, C2, C3), a protective film (OC), an orientation control projection (DPR), a counter electrode (COM), cell gap forming projection bodies (not shown in the drawing), an orientation film (AL2) and the like are formed. On an outer side of the glass substrate (SUB2) opposite to the liquid-crystal-layer (LC) side, a polarizer (POL2) is arranged.

On a liquid-crystal-layer (LC) side of the glass substrate (SUB1; also referred to as a TFT substrate), in order from the glass substrate (SUB1) toward the liquid crystal layer (LC), scanning lines (GL; also referred to as gate lines) (see FIG. 11), a gate insulation film (GI), video lines (DL; also referred to as source lines or drain lines), an insulation film (PAS1), an insulation film (PAS2), pixel electrodes (PIX), an orientation film (AL1) and the like are formed. On an outer side of the glass substrate (SUB1) opposite to the liquid crystal layer (LC) side, a polarizer (POL1) is arranged.

Here, the liquid crystal layer (LC) is made of negative liquid crystal.

Further, a phase difference plate may be arranged between the polarizer (POL1, POL2) and the glass substrate (SUB1, SUB2).

Further, although not shown in the drawing, a backlight is arranged outside the polarizer (POL1) on the glass substrate (SUB1) side and hence, the liquid crystal display device functions as a transmissive-type liquid crystal display device. In this case, a main surface side of the glass substrate (SUB2) constitutes an observation side.

In the liquid crystal display device having such a constitution, by applying an electric field between the pixel electrodes PIX and the counter electrodes (COM) formed on the glass substrate (SUB2) side, it is possible to re-arrange the liquid crystal molecules vertically as well as horizontally with respect to the substrate. The phase difference of the liquid crystal layer (LC) is changed corresponding to the intensity of the electric field and hence, the phase of the linear polarized light which passes through the polarizer (POL1) on the glass substrate (SUB1) side can be changed in the liquid crystal layer thus enabling the selection between “passing” and “non-passing” of light through the polarizer (POL2) on the opposite side. As a result, contrast of light can be displayed on the observation surface side.

Here, as shown in FIG. 17, the light blocking film (BM) is not arranged between color filters of the same color arranged adjacent to each other between the subpixels 40 (a pixel boundary 40y between two sub pixels 40 of the same color arranged adjacent to each other along the direction of the display line (X direction)) and hence, a numerical aperture is enhanced. Along with the enhancement of the numerical aperture, the transmissivity of the liquid crystal display panel can be enhanced. Provided that the brightness of the backlight is fixed, the display brightness can be increased along with the enhancement of the numerical aperture thus giving rise to an advantageous effect that the display quality is enhanced. Further, to acquire the same display brightness, the brightness of the backlight can be lowered by enhancing the numerical aperture thus reducing the power consumption of the backlight.

### Embodiment 7

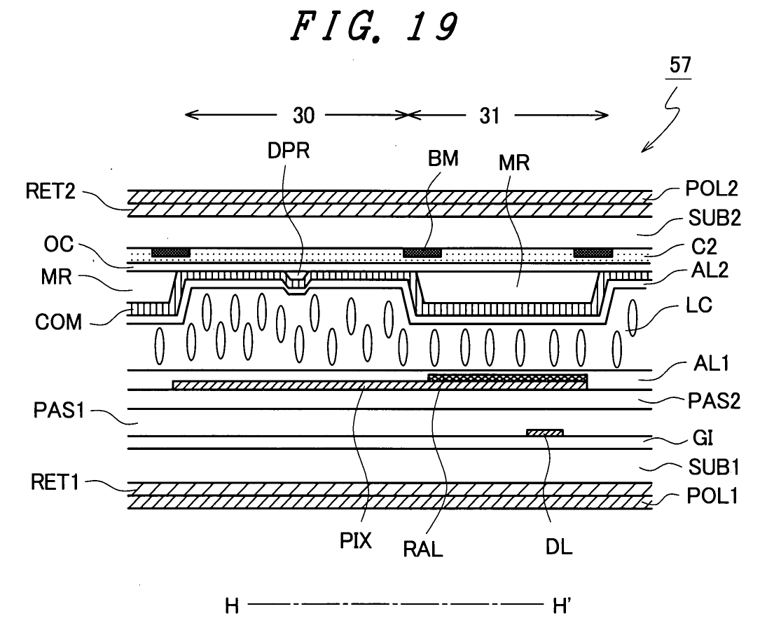

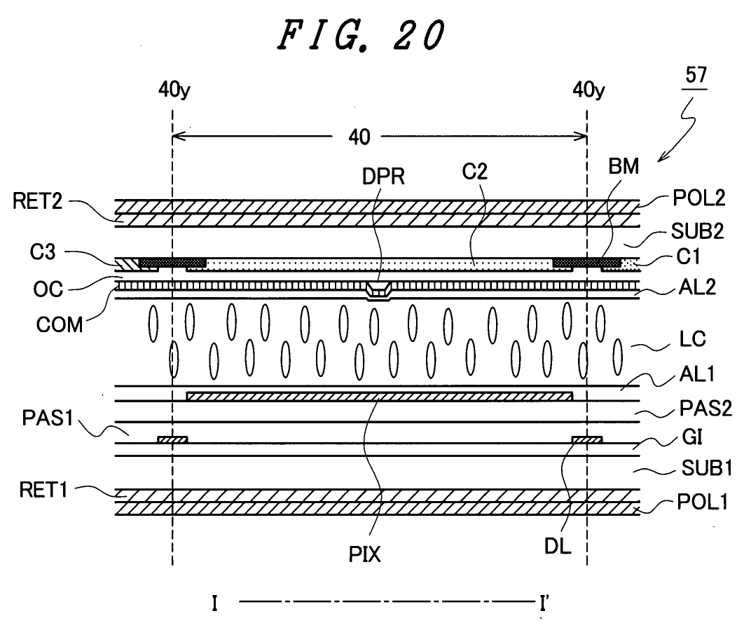

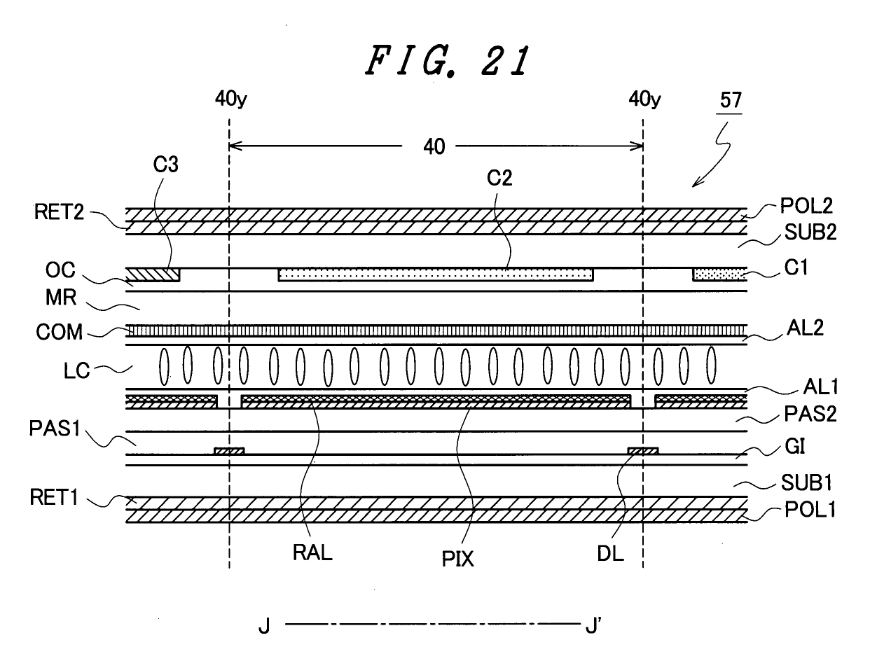

FIG. 18 to FIG. 21 are views showing a vertical-electric-field-method (VA method) transflective-type liquid crystal display device of the embodiment 7 according to the present invention. FIG. 18 is a plan view showing the electrode structure of the liquid crystal display panel on the TFT-substrate side, FIG. 19 is a cross-sectional view taken along a line H-H′ in FIG. 18 showing the cross-sectional structure of the liquid crystal display panel, FIG. 20 is a cross-sectional view taken along a line I-I′ in FIG. 18 showing the cross-sectional structure of the liquid crystal display panel, and FIG. 21 is a cross-sectional view taken along a line J-J′ in FIG. 18 showing the cross-sectional structure of the liquid crystal display panel.

Here, in FIG. 18 and FIG. 19, numeral 30 indicates a transmissive portion which constitutes a transmissive-type liquid crystal display panel, and numeral 31 indicates a reflective portion which constitutes a reflection-type liquid crystal display panel. Further, in FIG. 19 to FIG. 21, numeral 57 indicates a liquid crystal display panel. Further, FIG. 19 shows the cross-sectional structures of the transmissive portion 30 and reflective portion 31, FIG. 20 shows the cross-sectional structure of the transmissive portion 30, and FIG. 21 shows the cross-sectional structure of the reflective portion 31.

The liquid crystal display device of the embodiment 7 is characterized by adding a reflection display function to the constitution of the liquid crystal display device of the embodiment 6 and includes both of the transmissive portion 30 and the reflective portion 31 in 1 subpixel 40. The constitution is generally called as the transflective-type liquid crystal display panel. In this case, the transmissive portion 30 has the same constitution as the constitution of the transmissive portion 30 of the embodiment 6, while the reflective portion 31 has the constitution different from the constitution of the transmissive portion 30 of the embodiment 6.

The reflective portion 31 includes reflection electrodes (RAL) made of aluminum alloy or the like in the inside of a cell, and the reflection electrode (RAL) has a function of reflecting light incident from the observation surface. Further, it is necessary to allow circularly polarized light to be incident on the inside of the liquid crystal cell for a reflection display, and hence, phase difference plates (RET1, RET2) are arranged between the polarizers (POL1, POL2) and the reflection electrodes (RAL). The phase difference plates are usually formed of a quarter-wave plate respectively. A broad-band quarter-wave plate may be constituted by stacking the plurality of phase difference plates.

The liquid crystal layer (LC) of the transmissive portion 30 usually corresponds to a half-wave plate, and the liquid crystal layer (LC) of the reflective portion 31 usually corresponds to a quarter-wave plate and hence, it is necessary to change the retardation between the transmissive portion 30 and the reflective portion 31. The change of retardation can be realized by setting a cell gap length of the reflective portion 31 to a value approximately one half of the transmissive portion 30.

This constitution enables the liquid crystal display panel to perform a reflection display in addition to the transmission display. Further, the light blocking film (BM) is not arranged between color filters of the same color arranged adjacent to each other between the subpixels 40 (a pixel boundary 40y between two sub pixels 40 of the same color arranged adjacent to each other along the direction of the display line (X direction)) and hence, a numerical aperture is enhanced. Along with the enhancement of the numerical aperture, the transmissivity of the liquid crystal display panel can be enhanced. Provided that the brightness of the backlight is fixed, the display brightness can be increased along with the enhancement of the numerical aperture thus giving rise to an advantageous effect that the display quality is enhanced. Further, to acquire the same display brightness, the brightness of the backlight can be lowered by enhancing the numerical aperture thus reducing the power consumption of the backlight.

### Embodiment 8

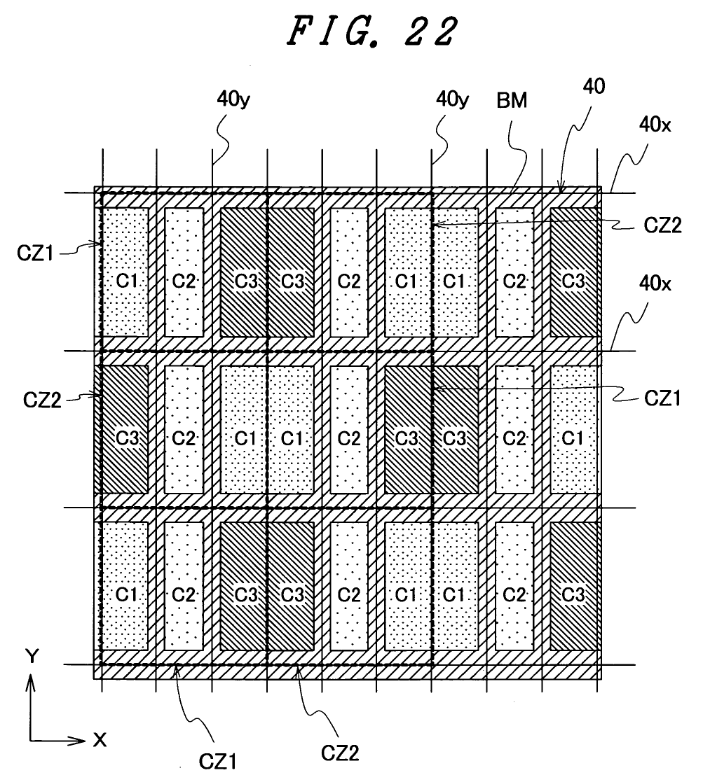

FIG. 22 is a plan view showing the arrangement of color filters of a liquid crystal display panel in a liquid crystal display device of the embodiment 8 according to the present invention. FIG. 22 corresponds to FIG. 1 which shows the constitution of the embodiment 1.

In FIG. 22, a color filter of color C1 and a color filter of color C3 are alternately arranged for every one row. That is, assuming that two neighboring display lines are constituted of one display line and another display line, a first group of sub pixels (first pixel) CZ1 of one display line and a second group of sub pixels (second pixel) CZ2 of another display line are arranged adjacent to each other in the arrangement direction of the display line (Y direction). Due to such an arrangement, it is possible to reduce the unnaturalness of display in a particular display screen (for example, in a checked pattern)

### Embodiment 9

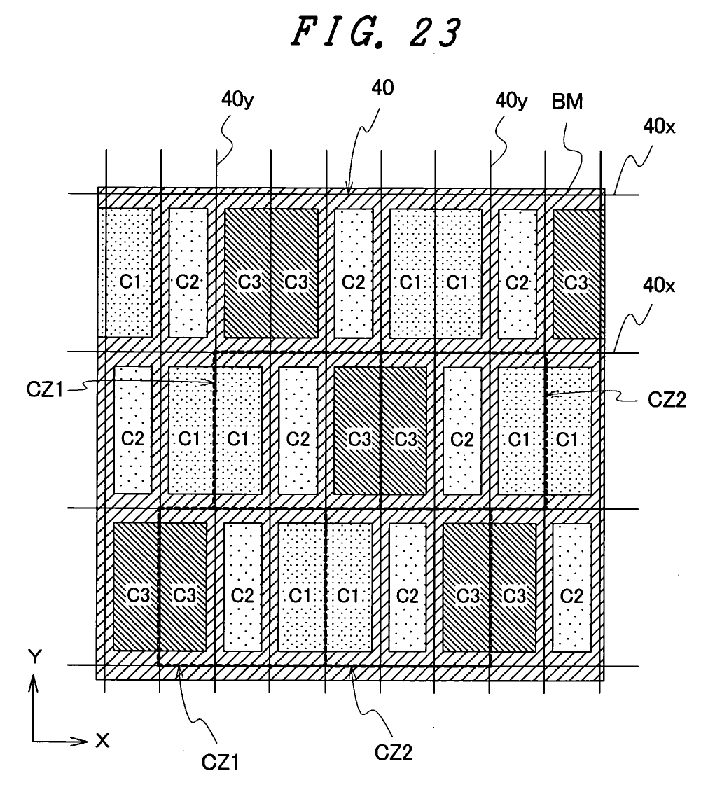

FIG. 23 is a plan view showing the arrangement of color filters of a liquid crystal display panel in a liquid crystal display device of the embodiment 9 according to the present invention. FIG. 23 corresponds to FIG. 1 which shows the constitution of the embodiment 1.

In FIG. 23, a color filter of color C1, a color filter of color C2 and a color filter of color C3 are displaced from each other for every row, and the color filter of color C1, the color filter of color C2 and the color filter of color C3 have the periodic structure in the column direction. Due to such an arrangement, it is possible to reduce the unnaturalness of display in a particular display screen (for example, checked pattern).

### Embodiment 10

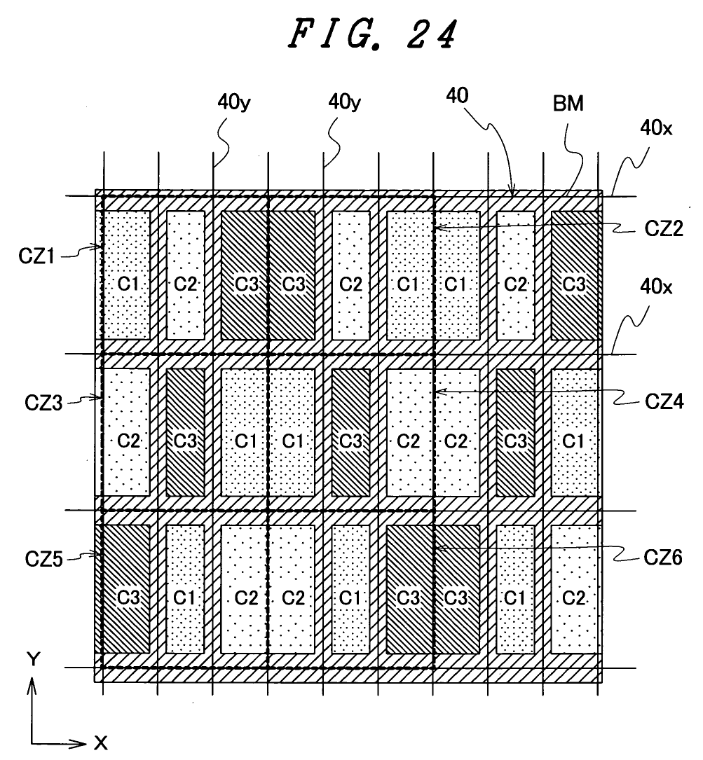

FIG. 24 is a plan view showing the arrangement of color filters of a liquid crystal display panel in a liquid crystal display device of the embodiment 10 according to the present invention. FIG. 24 corresponds to FIG. 1 which shows the constitution of the embodiment 1.

In FIG. 24, color filters of all colors C1, C2, C3 are arranged adjacent to each other between sub pixels. Due to such an arrangement, an average numerical aperture becomes a fixed value among the color filters of all colors and hence, it is possible to reduce the unnaturalness of color balance. Further, the color filters of colors C1, C2, C3 have the periodic structure also in the column direction and hence, it is possible to reduce the unnaturalness of display in a particular display screen (for example, checked pattern).

Here, the arrangement of the color filters of this embodiment is further explained.

Assuming that three neighboring display lines are constituted of a first-row (upper-row in the drawing) display line, a second-row (middle-row in the drawing) display line and a third-row (lower-row in the drawing) display line from above, the first-row display line is formed by alternately and repeatedly arranging a first group (first pixel) CZ1 in which three sub pixels 40 of red color (C1), green color (C2) and blue color (C3) are arranged in this order and a second group (second pixel) CZ2 in which three sub pixels 40 of blue color (C3), green color (C2) and red color (C1) are arranged in this order along the X direction such that two sub pixels 40 of red color (C1) and two sub pixels 40 of blue color (C3) are arranged adjacent to each other. The second-row display line is formed by alternately and repeatedly arranging a third group (third pixel) CZ3 in which three sub pixels 40 of green color (C2), blue color (C3) and red color (C1) are arranged in this order and a fourth group (fourth pixel) CZ4 in which three sub pixels 40 of red color (C1), blue color (C3) and green color (C2) are arranged in this order along the X direction such that two sub pixels 40 of green color (C2) and two sub pixels 40 of red color (C1) are arranged adjacent to each other. The third-row display line is formed by alternately and repeatedly arranging a fifth group (fifth pixel) CZ5 in which three sub pixels 40 of blue color (C3), red color (C1) and green color (C2) are arranged in this order and a sixth group (sixth pixel) CZ6 in which three sub pixels 40 of green color (C2), red color (C1) and blue color (C3) are arranged in this order along the X direction such that two sub pixels 40 of blue color (C3) and two sub pixels 40 of green color (C2) are arranged adjacent to each other.

### Embodiment 11

The advantageous effects acquired by the present invention are described in conjunction with the embodiment 11.

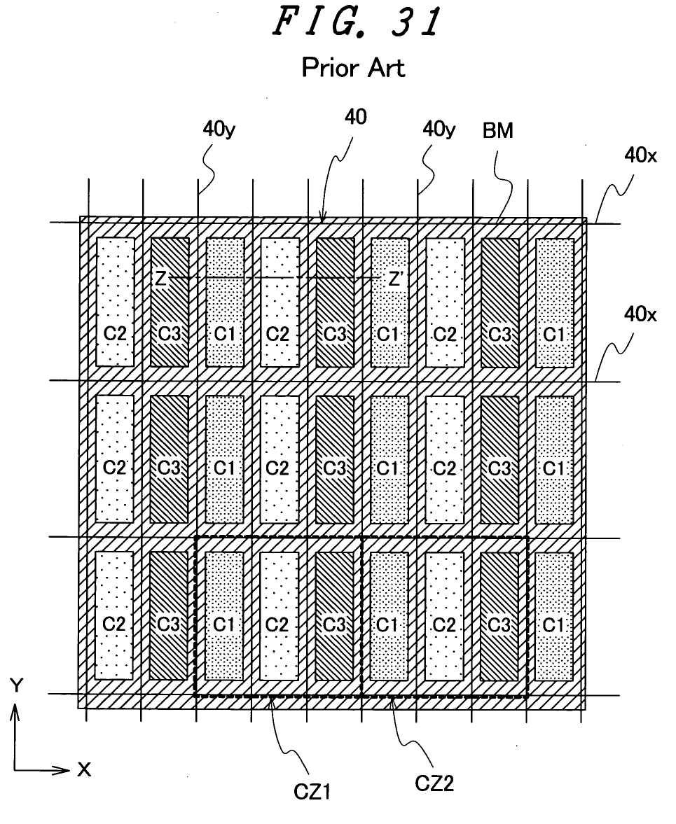

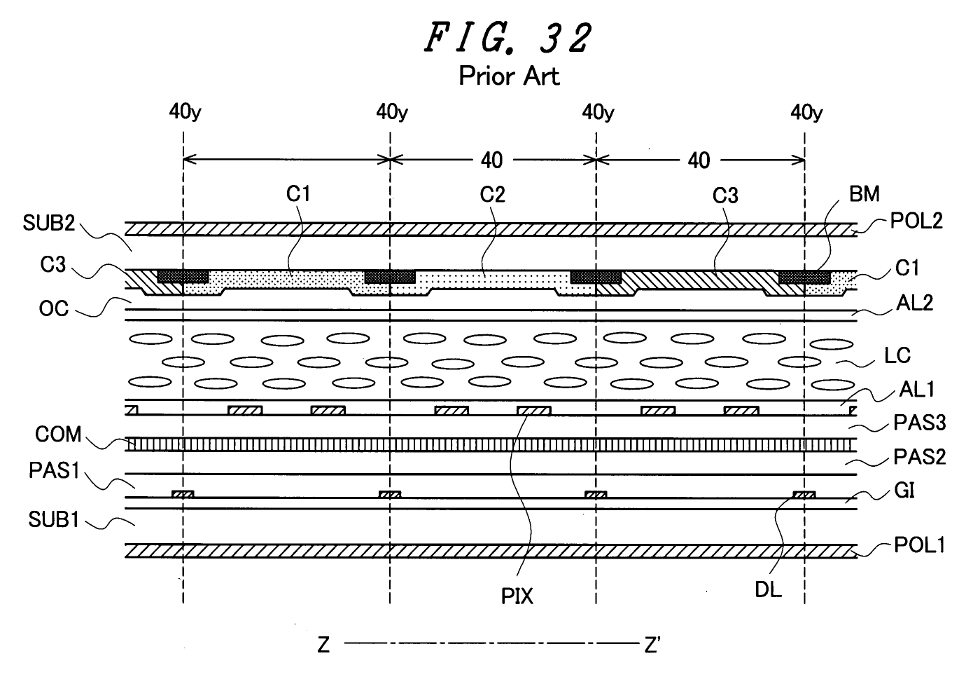

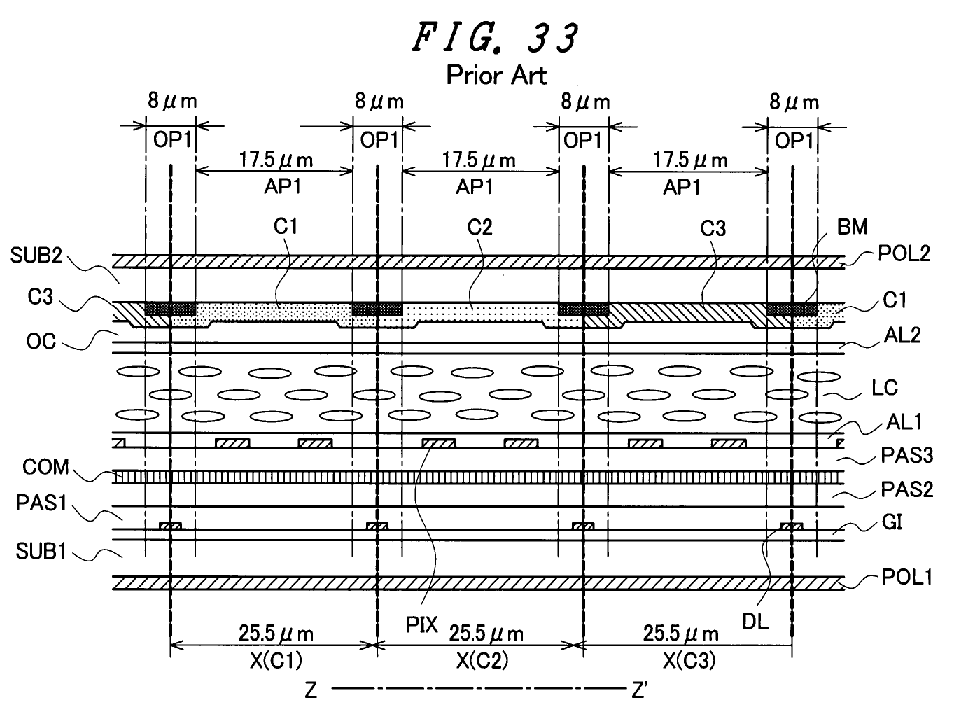

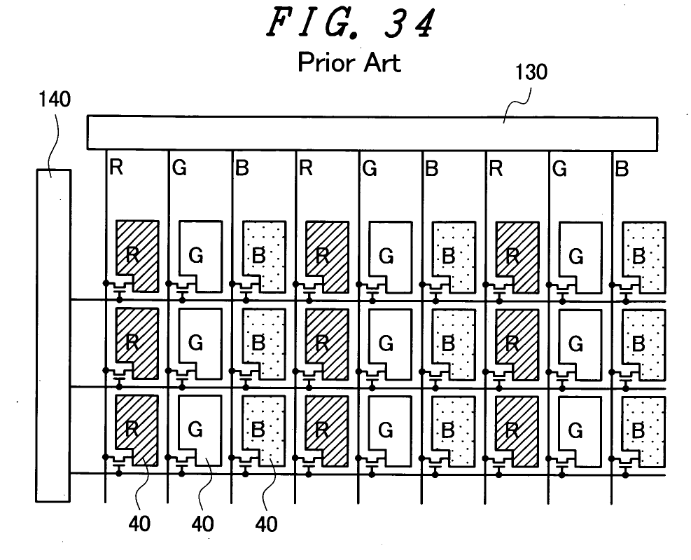

First of all, the structure of a conventional liquid crystal display device is explained. FIG. 31 is a plan view showing the arrangement of color filters of the conventional liquid crystal display panel, FIG. 32 is a cross-sectional view taken along a line Z-Z′ in FIG. 31 showing the cross-sectional structure of the conventional liquid crystal display panel, and FIG. 33 is a cross-sectional view showing sizes of one example of the conventional liquid crystal display panel in FIG. 32.

In FIG. 33, a width of 1 sub pixel 40 is set to 25.5 μm and a width of 1 pixel is set to 76.5 μm (25.5 μm×3). Assuming that a width of a light blocking film (BM) is set to 8 μm, an opening width of 1 sub pixel 40 is 17.5 μm (25.5 μm−8 μm) and hence, an opening width of 1 pixel is 52.5 μm (17.5 μm×3).

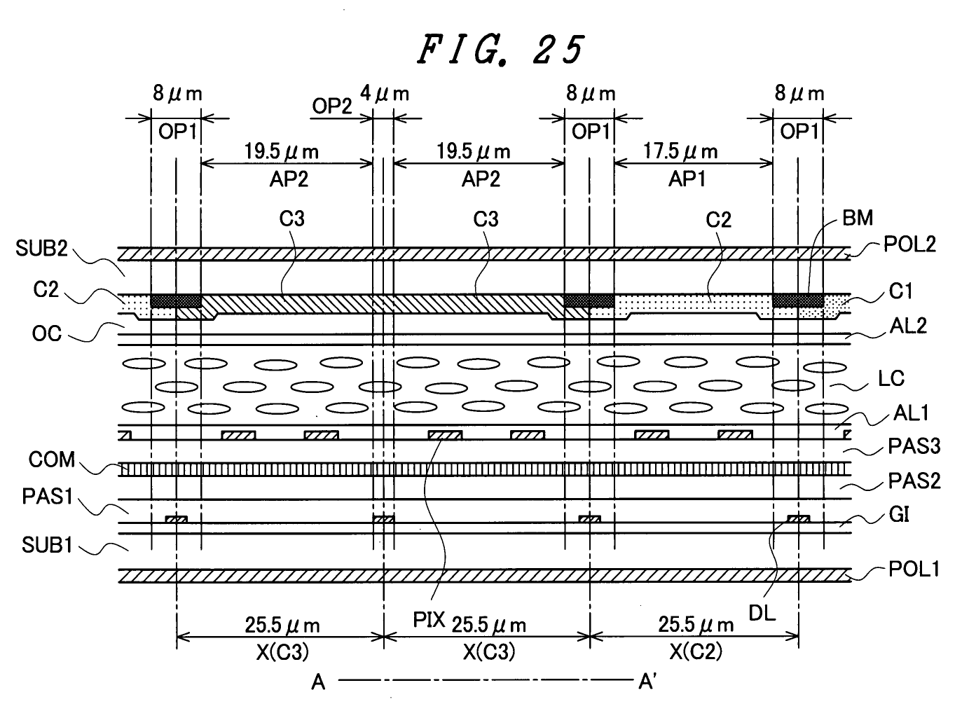

Next, the structure of the liquid crystal display device according to the present invention is explained. FIG. 25 is a cross-sectional view taken along a line A-A′ in FIG. 1 showing the cross-sectional structure of the liquid crystal display panel in a liquid crystal display device of the embodiment 11 according to the present invention.

In FIG. 25, a width of 1 sub pixel is set to 25.5 μm and a width of 1 pixel is set to 76.5 μm (25.5 μm×3). Assuming that a width of the light blocking film (BM) is set to 8 μm, an opening width of 1 sub pixel 40 is 19.5 μm (25.5 μm−4 μm−2 μm) in the sub pixel having no light blocking film (BM) on one end thereof, and is 17.5 μm (25.5 μm−8 μm) in a sub pixel having the light blocking film (BM) on both ends thereof and hence, an opening width of 1 pixel is 56.5 μm (19.5 μm×2+17.5 μm).

Here, assuming that the conventional example and the present invention have the same length in the depth direction (Y direction), the numerical aperture is proportional to the opening width. To compare the numerical aperture (opening width) of the conventional example and the numerical aperture (opening width) of the present invention, a numerical aperture ratio is expressed by a following formula:

Numerical aperture ratio (numerical aperture of the present invention/numerical aperture of the conventional example)=56.5/52.5≅1.08

Accordingly, the constitution of the present invention can enhance the numerical aperture thereof compared to the numerical aperture of the conventional example by approximately 8%.

Here, although the width of 1 sub pixel is 25.5 μm in this embodiment, in a high definition panel in which 1 sub pixel has a smaller width, a ratio of area that a black matrix occupies within 1 sub pixel is increased and hence, the higher the definition of liquid crystal panel, the larger an enhancement effect of the numerical aperture becomes.

### Embodiment 12

The advantageous effects acquired by the present invention are described in conjunction with the embodiment 12.

First of all, the structure of the conventional liquid crystal display device is explained. In FIG. 33, a width of 1 sub pixel 40 is set to 25.5 μm and a width of 1 pixel is set to 76.5 μm (25.5 μm×3). Assuming that a width of a light blocking film (BM) is set to 8 μm, an opening width of 1 sub pixel 40 is 17.5 μm (25.5 μm×8 μm) and hence, an opening width of 1 pixel is 52.5 μm (17.5 μm×3).

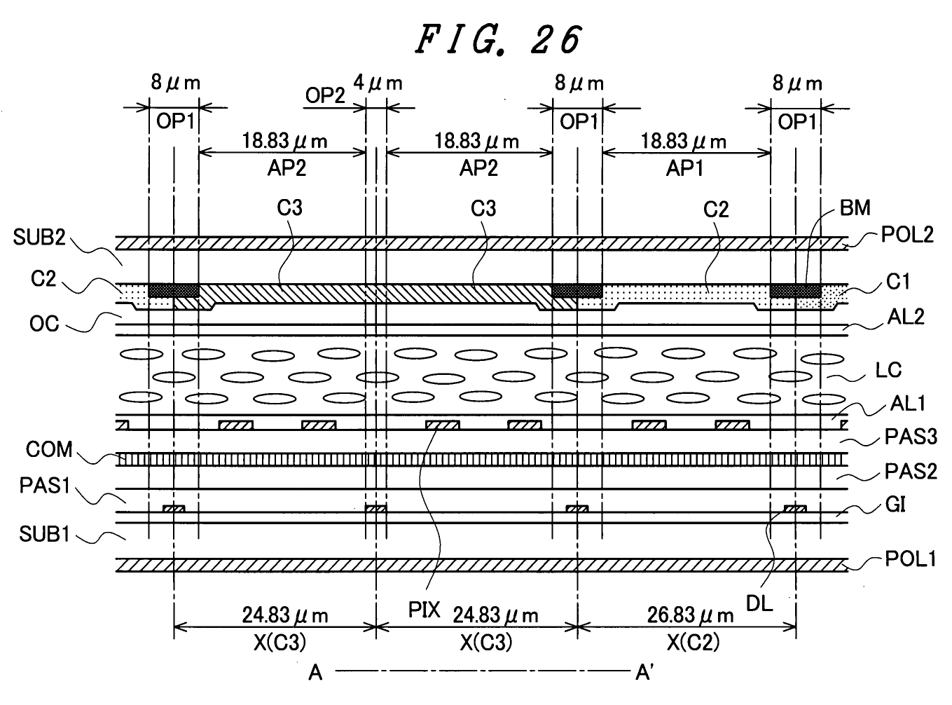

Next, the structure of the liquid crystal display device according to the present invention is explained. FIG. 26 is a cross-sectional view taken along a line A-A′ in FIG. 1 showing the cross-sectional structure of the liquid crystal display panel in a liquid crystal display device of the embodiment 12 according to the present invention.

In FIG. 26, a width of 1 sub pixel 40 differs between the sub pixel 40 having no light blocking film (BM) on one end thereof and the sub pixel 40 having the light blocking film (BM) on both ends thereof. The width of the sub pixel 40 having no light blocking film (BM) on one end thereof is 24.83 μm, and the width of the sub pixel 40 having the light blocking film (BM) on both ends thereof is 26.83 μm. The widths of the sub pixels are set in the above-mentioned manner so as to allow all sub pixels 40 to have the same fixed opening width. Here, assuming that the width of the light blocking film (BM) is set to 8 μm, all sub pixels 40 have the same opening width of 18.83 μm and the opening width of 1 pixel is 56.5 μm (18.83 μm×3).

Here, assuming that the conventional example and the present invention have the same length in the depth direction (Y direction), the numerical aperture is proportional to the opening width. To compare the numerical aperture (opening width) of the conventional example and the numerical aperture (opening width) of the present invention, a numerical aperture ratio is expressed by a following formula:

Numerical aperture ratio (numerical aperture of the present invention/numerical aperture of the conventional example)=56.5/52.5≅1.08

Accordingly, the constitution of the present invention can enhance the numerical aperture thereof compared to the numerical aperture of the conventional example by approximately 8%.

Here, although the width of 1 sub pixel is 25.5 μm in this embodiment, in a high definition panel in which 1 sub pixel has a smaller width, a ratio of area that a black matrix occupies within 1 sub pixel is increased and hence, the higher the definition of liquid crystal panel, the larger an enhancement effect of the numerical aperture becomes.

Further, since all sub pixels (all colors) have the same fixed opening width in the embodiment, the liquid crystal display panel can perform a display without destroying a color balance.

### Embodiment 13

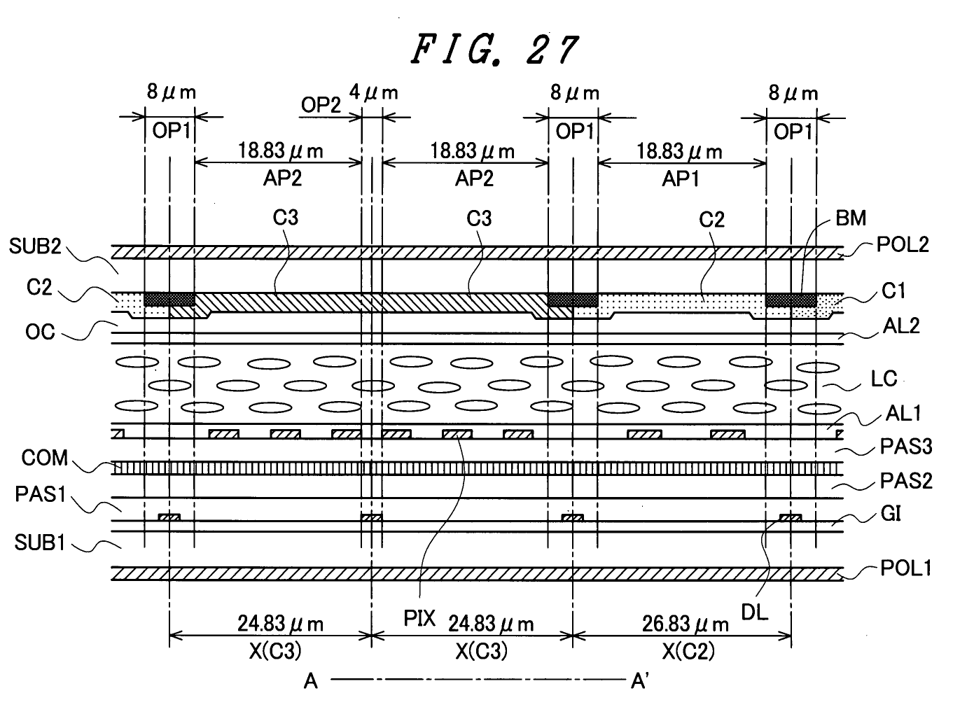

The embodiment 13 corresponds to the embodiment 12. FIG. 27 is a cross-sectional view taken along a line A-A′ in FIG. 1 showing the cross-sectional structure of a liquid crystal display panel in a liquid crystal display device of the embodiment 13 according to the present invention.

The constitution which makes the embodiment shown in FIG. 27 different from the constitution shown in FIG. 26 lies in that the number of pixel electrodes is made different between a sub pixel having no light blocking film (BM) on one end thereof and a sub pixel having a light blocking film (BM) on both ends thereof. In FIG. 27, the sub pixel having a larger width has the larger number of pixel electrodes. In the lateral electric field method, the larger the number of pixel electrodes, the higher the transmissivity of the sub pixel becomes and hence, it is more desirable to increase or decrease the number of electrodes in conformity with the width of the sub pixel.

### Embodiment 14

The embodiment 14 relates to an output circuit of a video voltage. FIG. 34 is a constitutional view of the conventional example. In FIG. 34, numeral 130 indicates a video line drive circuit, and numeral 140 indicates a scanning line drive circuit. In the conventional example, the sub pixels are arranged in order of color R, color G, color B, color R, color G, color B and hence, the video voltage outputted from the video line drive circuit 130 is also outputted in order of color R, color G, color B, color R, color G, color B corresponding to the arrangement of the sub pixels.

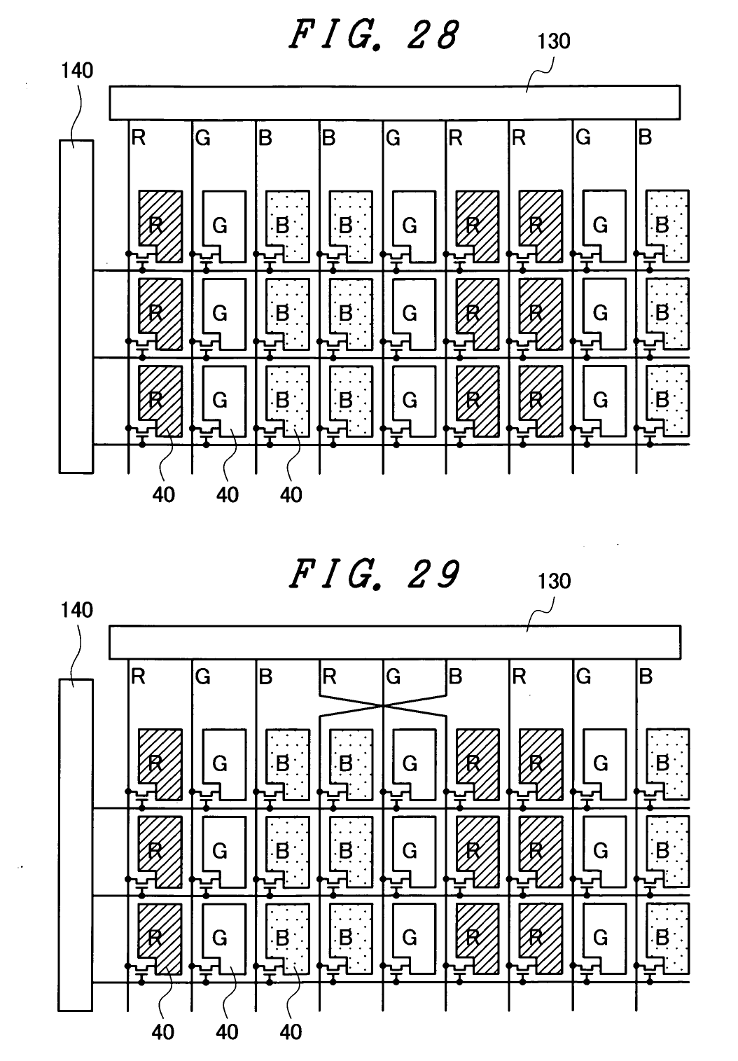

On the other hand, the constitution of the output circuit of the video voltage of this embodiment is shown in FIG. 28 and FIG. 29. In FIG. 28, corresponding to the arrangement of sub pixels in order of color R, color G, color B, color B, color G, color R, the video voltages are outputted from the video line drive circuit 130 in order of color R, color G, color B, color B, color G, color R.

Further, in FIG. 29, although the order of the video voltage outputted from the video line drive circuit 130 is in order of color R, color G, color B, color R, color G, color B in the same manner as the conventional example, the sub pixels are arranged in order of color R, color G, color B, color B, color G, color R. Accordingly, in the group in which the sub pixels are arranged in order of color B, color G, color R, a video line for color R and a video line for color B intersect with each other thus converting the order of the video voltage into the order of color R, color G, color B, color B, color G, color R. As a method for intersecting the signal lines, there is provided a method which connects one line with another line through a contact hole by way of an interlayer insulation film.

### Embodiment 15

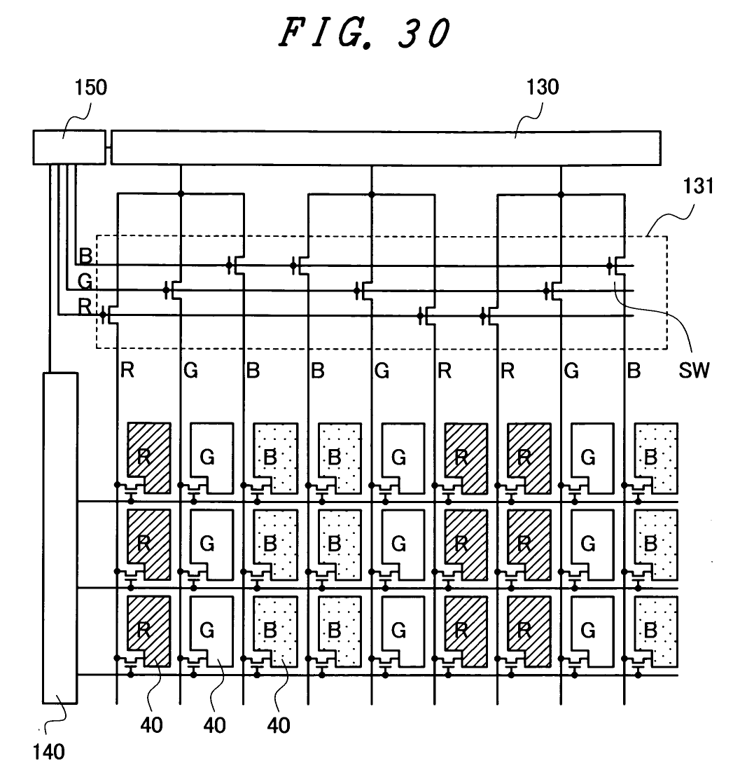

An embodiment 15 also relates to an output circuit of a video voltage. FIG. 30 shows the constitution of the output circuit of the video voltage of this embodiment. Here, in FIG. 30, numeral 131 indicates an RGB selection circuit and numeral 150 indicates a power source.

In this embodiment, a video voltage is outputted from a video line drive circuit 130 in order of color R, color G, color B within 1 horizontal scanning period. Along with the outputting of the video voltage, the RGB selection circuit 131 supplies the video voltage outputted in order of color R, color G, color B to the respective video lines of color R, color G, color B from the video line drive circuit 130.

In this embodiment, by changing a control signal applied to a gate of a switching element SW in the inside of the RGB selection circuit 131, the order of video voltage outputted in order of color R, color G, color B from the video line drive circuit 130 into the order of color R, color G, color B, color B, color G, color R.

The present invention made by inventors has been specifically explained in conjunction with embodiments heretofore. However, it is needless to say that the present invention is not limited to the above-mentioned embodiments and various modifications can be made without departing from the gist of the present invention.

For example, the present invention is applicable to a display device of another method such as an organic EL display device.

What is claimed is:

1. A liquid crystal display device including a liquid crystal display panel which has a first substrate, a second substrate, and a liquid crystal layer sandwiched between the first substrate and the second substrate, wherein
the liquid crystal display panel includes a light blocking film and a plurality of sub pixels arranged in a matrix array,
each one of the plurality of sub pixels includes a pixel electrode, a counter electrode and a color filter,
an electric field is generated between the pixel electrode and the counter electrode thus driving liquid crystal of the liquid crystal layer, wherein
the plurality of sub pixels includes two neighboring sub pixels which are arranged adjacent to each other along the direction of a display line and have the color filters of the same color,
the light blocking film is formed so as to cover respective pixel boundaries of the plurality of sub pixels except for the pixel boundary between the two neighboring sub pixels, and
the respective pixel electrodes of the two neighboring sub pixels are formed independently from each other.

2. A liquid crystal display device according to claim 1, wherein the two neighboring sub pixels share the color filter in common.

3. A liquid crystal display device according to claim 1, wherein the plurality of sub pixels is divided into three sub pixels of a first group which are arranged in order of first color, second color and third color, and three sub pixels of a second group which are arranged in order of the third color, the second color and the first color, and the three sub pixels of the first group and the three sub pixels of the second group are alternately arranged in the direction of the display line.

4. A liquid crystal display device according to claim 1, wherein the pixel electrodes and the counter electrodes are formed on the first substrate, and the color filters and the light blocking film are formed on the second substrate.

5. A liquid crystal display device according to claim 4, wherein the pixel electrode and the counter electrode are stacked to each other by way of an insulation film.

6. A liquid crystal display device according to claim 4, wherein the pixel electrode and the counter electrode are formed on the same layer.

7. A liquid crystal display device according to claim 4, wherein each one of the plurality of sub pixels includes a transmissive portion and a reflective portion.

8. A liquid crystal display device according to claim 1, wherein the pixel electrodes are formed on the first substrate, and the color filters, the light blocking film and the counter electrodes are formed on the second substrate.

9. A liquid crystal display device according to claim 8, wherein each one of the plurality of sub pixels includes a transmissive portion and a reflective portion.

10. A liquid crystal display device according to claim 1, wherein the plurality of sub pixels is arranged such that the sub pixels of the same color are arranged adjacent to each other between two neighboring display lines.

11. A liquid crystal display device according to claim 1, wherein the plurality of sub pixels is arranged such that the sub pixels of different colors are arranged adjacent to each other between two neighboring display lines.

12. A liquid crystal display device according to claim 1, wherein assuming that two neighboring display lines are constituted of one display line and another display line, the two neighboring sub pixels on the one display line and the two neighboring sub pixels on the another display line are arranged adjacent to each other, and the respective color filters have different colors from each other.

13. A liquid crystal display device comprising:
a liquid crystal display panel which has a first substrate, a second substrate, and a liquid crystal layer sandwiched between the first substrate and the second substrate; and
a video line drive circuit, wherein
the liquid crystal display panel includes a plurality of sub pixels arranged in a matrix array, and a plurality of video lines which supplies video voltages to the respective sub pixels of the plurality of sub pixels,
each one of the plurality of sub pixels includes a pixel electrode and a counter electrode, and
an electric field is generated between the pixel electrode and the counter electrode thus driving liquid crystal of the liquid crystal layer, wherein
the plurality of sub pixels is divided into three sub pixels of a first group which are arranged in order of first color, second color and third color, and three sub pixels of a second group which are arranged in order of the third color, the second color and the first color,
the three sub pixels of the first group and the three sub pixels of the second group are alternately arranged in the direction of the display line, and
the respective pixel electrodes of two neighboring sub pixels formed of the sub pixels of the same color arranged adjacent to each other along the direction of the display line are formed independently from each other,
output terminals of the video line drive circuit are arranged sequentially in order of the first color, the second color and the third color, and
a video line which supplies the video voltage to the sub pixel of first color of the second group and a video line which supplies the video voltage to the sub pixel of third color of the second group intersect with each other.

14. A liquid crystal display device comprising:
a liquid crystal display panel which has a first substrate, a second substrate, and a liquid crystal layer sandwiched between the first substrate and the second substrate; and
a video line drive circuit, wherein
the liquid crystal display panel includes a plurality of sub pixels arranged in a matrix array, and a plurality of video lines which supplies video voltages to the respective sub pixels of the plurality of sub pixels,
each one of the plurality of sub pixels includes a pixel electrode and a counter electrode, and
an electric field is generated between the pixel electrode and the counter electrode thus driving liquid crystal of the liquid crystal layer, wherein
the plurality of sub pixels is divided into three sub pixels of a first group which are arranged in order of first color, second color and third color, and three sub pixels of a second group which are arranged in order of the third color, the second color and the first color,
the three sub pixels of the first group and the three sub pixels of the second group are alternately arranged in the direction of the display line,
the respective pixel electrodes of two neighboring sub pixels formed of the sub pixels of the same color arranged adjacent to each other along the direction of the display line are formed independently from each other, and
the liquid crystal display device includes a selection circuit which connects respective three video lines which supply the video voltages to the three sub pixels of the first group and respective three video lines which supply the video voltages to the three sub pixels of the second group to corresponding terminals of the video line drive circuit.
